(19) United States
(12) Patent Application Publication
(10) Pub. No.: US 2016/0005001 A1
(43) Pub. Date: Jan. 7, 2016

(54) Social Relation Management Apparatuses, Methods and Systems

(71) Applicant: Monster Worldwide, Inc., Weston, MA (US)

(72) Inventors: Javid Muhammedali, Wellesley, MA (US); Andrew Fercu, Atlanta, GA (US)

(21) Appl. No.: 14/711,336

(22) Filed: May 13, 2015

Related U.S. Application Data
(60) Provisional application No. 61/992,816, filed on May 13, 2014.

(51) Int. Cl. G06Q 10/10; H04L 29/08; G06Q 50/00

(52) U.S. Cl. CPC G06Q 10/1053; G06Q 50/01; H04L 67/306

(57) ABSTRACT

The Social Relation Management Apparatuses, Methods and Systems (“SRM”) transform automated social information gathering inputs via SRM components into activatable social account outputs. A social client outreach apparatus, comprising a processor and memory to obtain inactive client account information from social interaction of other users and then populate an actionable inactive social account with the obtained inactive client account information. Thereafter, the SRM may generate an actionable active social account from the populated account upon receiving an indication and verification of intended use from an interested client.

This application for letters patent disclosure document describes inventive aspects that include various novel innovations (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### PRIORITY CLAIM

Applicant hereby claims benefit to priority under 35 USC 5119 to U.S. provisional patent application Ser. No. 61/992,816, filed May 13, 2014, entitled “SOCIAL RELATION MANAGEMENT APPARATUSES, METHODS AND SYSTEMS,” (attorney docket no. MONSTER-101PV). The entire contents of the aforementioned applications are herein expressly incorporated by reference.

### FIELD

The present innovations generally address relationship management systems, and more particularly, include Social Relation Management Apparatuses, Methods and Systems.

However, in order to develop a reader's understanding of the innovations, disclosures have been compiled into a single description to illustrate and clarify how aspects of these innovations operate independently, interoperate as between individual innovations, and/or cooperate collectively. The application goes on to further describe the interrelations and synergies as between the various innovations; all of which is to further compliance with 35 U.S.C. §112.

### BACKGROUND

Customer Relationship Management software exists and is used to help companies manage interactions with their existing customers and other third parties, but such existing systems fail to provide many automated features as will now be introduced.

### BRIEF DESCRIPTION OF THE DRAWINGS

Appendices and/or drawings illustrating various, non-limiting, example, innovative aspects of the Social Relation Management Apparatuses, Methods and Systems (hereinafter “SRM”) disclosure, include:

FIG. 1 shows an exemplary network environment for the SRM;

FIGS. 2-3 show a datagraph diagram illustrating embodiments of an employment candidate profile generation process for the SRM;

FIG. 4 shows a datagraph diagram illustrating embodiments of a recruiting campaign process for the SRM;

FIGS. 5-7 show a logic flow diagram illustrating embodiments of a employment and recruiter matching process for the SRM;

FIG. 8 shows a logic flow diagram illustrating embodiments of a first automated recruitment campaign process for the SRM;

FIG. 9 shows a logic flow diagram illustrating embodiments of a second automated recruitment campaign process for the SRM;

FIG. 10 shows a logic flow diagram illustrating embodiments of a third automated recruitment campaign process for the SRM;

FIG. 11 shows a conceptualization of the means by which the SRM gathers employment information from a plurality of social media network sites;

FIG. 11A shows an exemplary logic flow diagram illustrating embodiments of a social media recruiting message generation process for the SRM;

FIGS. 11B-11D show exemplary screen displays presented to a recruiter for generating a social media recruiting message during the process of FIG. 11A;

FIG. 12 shows an exemplary screen display of a social media account from which information is obtained by the SRM;

FIGS. 13-29 show exemplary screen displays presented to a recruiter to establish and analyze an employment recruiting campaign using the SRM;

FIGS. 30-32 show exemplary screen displays presented to an employment candidate using the SRM; and

FIG. 33 shows a block diagram illustrating embodiments of a controller for the SRM.

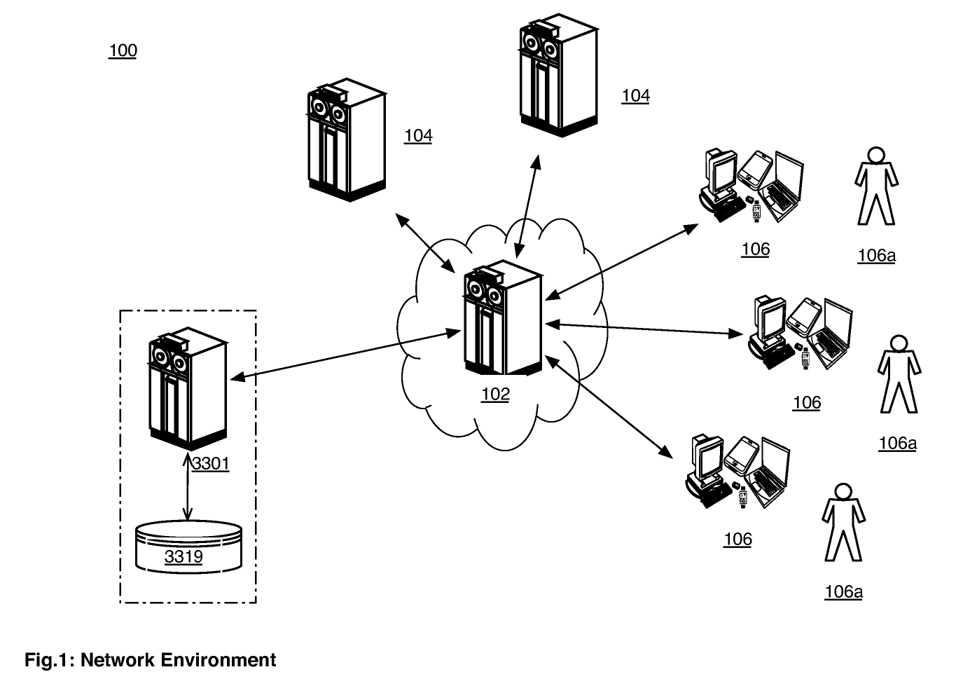

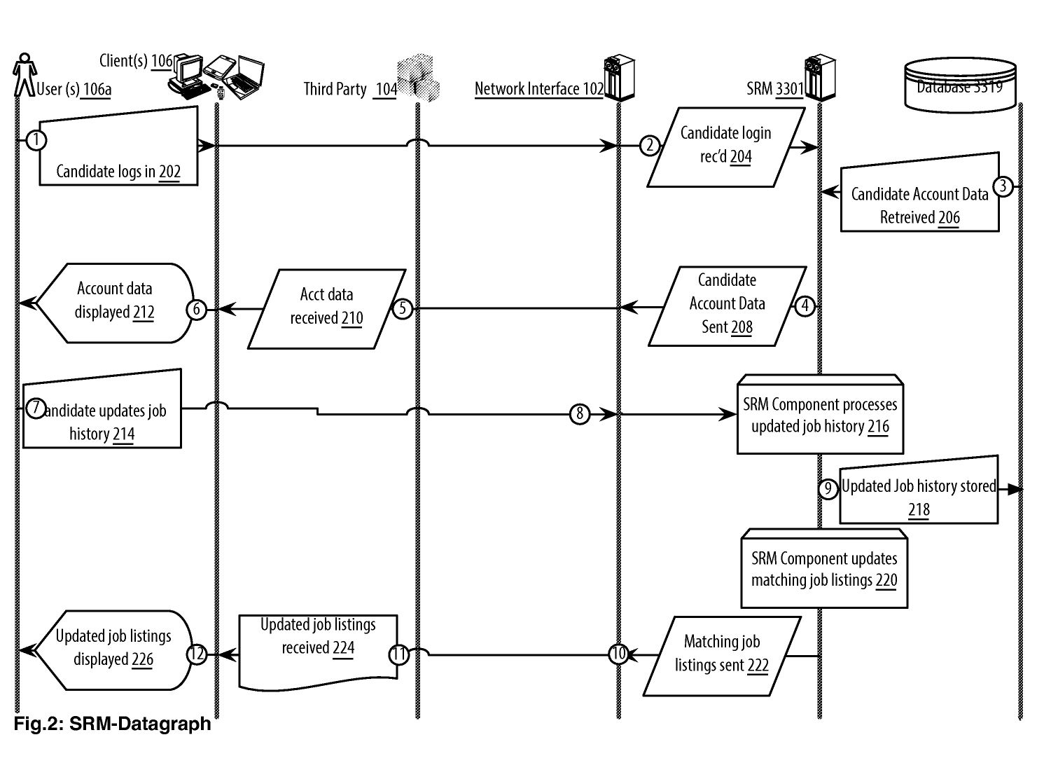

Generally, the leading number of each citation number within the drawings indicates the figure in which that citation number is introduced and/or detailed. As such, a detailed discussion of citation number 101 would be found and/or introduced in FIG. 1. Citation number 201 is introduced in FIG. 2, etc. Any citation and/or reference numbers are not necessarily sequences but rather just example orders that may be rearranged and other orders are contemplated.

### DETAILED DESCRIPTION

The Social Relation Management Apparatuses, Methods and Systems (hereinafter “SRM”) transforms automated social information gathering inputs, via SRM components (e.g., information mapping, etc.), into activatable social account outputs. The SRM components, in various embodiments, implement advantageous features as set forth below. In general, the SRM system is an online computing system that facilitates interactions between employment candidates search for employment opportunities and employment recruiters looking for individuals to fill one or more available job positions.

In various embodiments, the SRM system may store and monitor job listings provided by employment recruiters as part of an employment recruiting campaign or the like. The SRM system may also create, update, monitor and store employment candidate profiles employment candidates. The job listings may be searched by employment candidates using search functions provided by the SRM system. The employment candidate profiles may be searched by recruiters using search and campaign functions provided by the SRM system.

In various embodiments, the SRM system also includes automated, programmed functionalities for generating pre-formatted résumés on behalf of employment candidates, using information obtained from and entered by the candidate. In additional embodiments, the SRM may obtain job-related information regarding candidates from third-party social media sites, other employment sites, student and alumni databases of educational institutions, and other available online data sources. The information from these sources may be parsed by the SRM system and compared to a knowledge base of stored job-related information, by comparing parsed text to stored standardized descriptors to each job and its constituent job functions. Such descriptors may then be imported into pre-determined sections of the résumé, and stored on behalf of the candidate with the candidate's SRM profile. The candidate's profile may, in various separate embodiments, be maintained privately for use exclusively by the SRM, or may be available to recruiters only when the profile matches a recruiter employment campaign requirements, or may be maintained publicly such that any users of the SRM system may view the employment profile. The degree of availability may be established by the candidate or the SRM system.

In various embodiments, the SRM system may provide functions to automate an employment recruiting campaign on behalf of recruiters or employers. In particular, the SRM system may allow the recruiter to generate a job listing for an open employment position and provide a standardized selection of requisite job skills, job requirements, as well as a geographic location or region of the position. The SRM System also allows the recruiter to generate messages that are to be sent to desired candidates. Such automated messages may be scheduled to occur at various times. Follow-up messages with scheduled send dates may also be created by the recruiter and/or the SRM system. For example, when a candidate receives a message from a message campaign, the SRM system knows at all times whether the candidate has replied to that message (or any message that pertains to the associated message campaign) or if the candidate has clicked on a link in any received campaign messages. The SRM system uses that data to determine whether or not the candidate should receive an automated follow-up message. If the candidate has either replied or clicked on a link, they have performed the desired action and the follow-up message is not sent. This same behavior exists for future follow-up messages that may be sent as part of that recruiting campaign as well.

Recurring campaigns may be established in like manner. For example, if an employment campaign is to be implemented periodically or seasonally, such requirements can be established for each campaign stored and executed by the SRM system. When the established time of recurrence is reached, the SRM system will automatically re-launch the established recurring employment campaign.

In various embodiments, the SRM system may monitor activities of employment candidates on the SRM system, or on third-party social media sites, in order to automatically update the employment candidate's profile and résumé with current information. The information may come from social media accounts associated with the candidate, or may come from social media activities of others that mention or otherwise reference the candidate.

The SRM may allow recruiters to establish recruiting campaigns of a job-related web site, such as MONSTER.COM or JOBS.COM. The recruiting campaigns may also be established and operated from third-party web sites owned by a recruiter or employer. Furthermore, the SRM allows recruiters to automatically establish and generate recruiting campaign messages that are pre-formatted from campaign information established by the recruiter, and which are then distributed and promoted on third-party social media sites such as TWITTER, FACEBOOK and LINKED-IN. The SRM system may also monitor the effectiveness of recruiting campaigns by monitoring the frequency, type and number of communications or other interactions between recruiters and candidates via the SRM system or on social media, as well as the number of candidates that do not respond to a campaign. These statistics may be compared to established norms to determine an effectiveness of a campaign. The SRM system may restrict recruiters' activities and privileges on the SRM site to varying degrees when employment campaigns are determined to be under-performing, and/or may reward recruiters having successful campaigns by granting further campaign privileges and functionalities without additional cost to the recruiter.

Recruiters may be charged fees to use the SRM functionalities described herein. Such fees may be dynamically priced based on recruiting job type, location of the job, and/or the recruiter's campaign performances, as described in more detail herein.

These features of the SRM system introduced herein will now be described in more detail below.

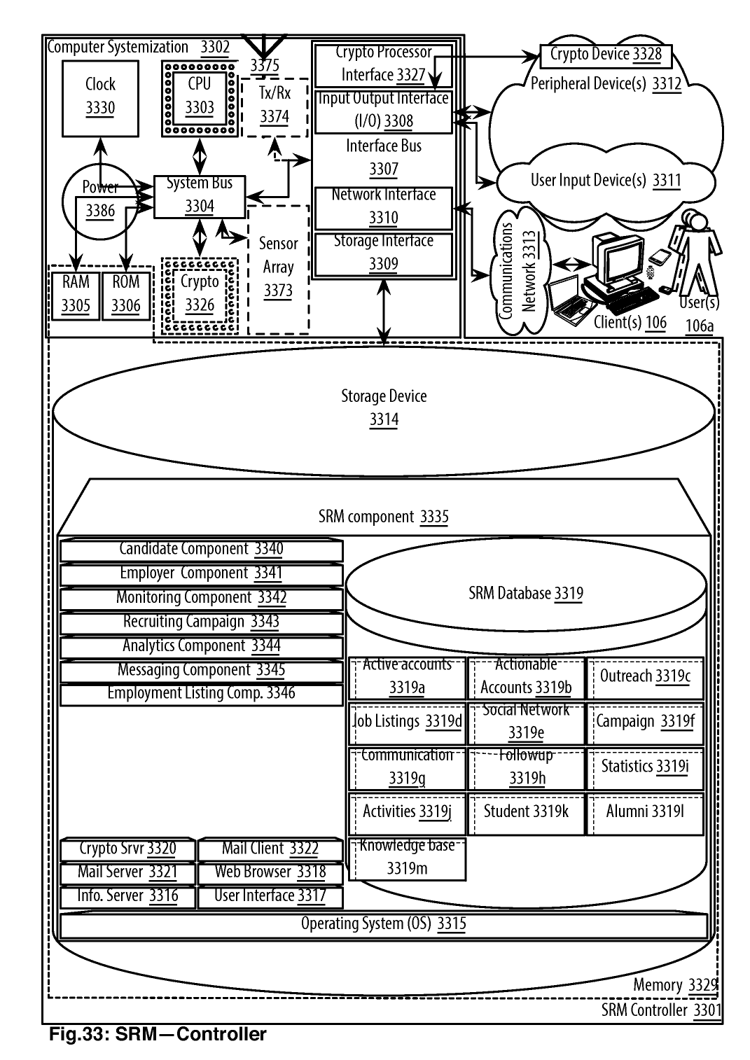

FIG. 1 shows a block diagram illustrating embodiments of the network environment 100 of the SRM. The network environment 100 may include an SRM Server 3301, the functions and components of which described in detail below with respect to FIG. 33. The SRM Server 3301 may comprise one or many servers, which may collectively be included in the SRM System.

The network environment 100 may further include an SRM Database 3319, which may be provided to store various information used by the SRM Server 3301 including client portfolio data, financial transaction data, and any other data as described, contemplated and used herein.

The network environment 100 may further include a Network Interface Server 102, which, for example, enables data network communication between the SRM Server 3301, one or more Social Network Server(s) 104, and Client Terminal(s) 106 over a data communications network, in accordance with the interactions as described herein.

The one or more Client Terminals 106 may be any type of computing device that may be used by Clients 106a to connect with the SRM Server 3301 over a data communications network. Such devices may include, but are not limited to, personal computers, tablet devices, mobile computing devices, mobile telephones, smartphones, and the like. Clients 106a, in turn, may be employment candidates who are looking for employment opportunities offered by recruiters, as described further herein.

The Social Media Server(s) 104 may be operated by third-party social media site operators. Such sites may include well-known social media websites such as: FACEBOOK, TWITTER, MYSPACE, GOOGLE CIRCLES, or other websites of similar or like functionalities. Such sites may also include well-known employment related social media sites such as LINKEDIN, MONSTER.COM, or JOBS.COM. Any or all types of Social Media servers may be employed in conjunction with the SRM System in order to accomplish the functionalities described herein. The ability to research, construct and institute an employment résumé solely from information obtained from third-party social media sites represents a technological advancement in the field of network communications by which such network communications are efficiently harnessed to quickly and correctly facilitate an application for employment to a recruiter by a candidate.

The servers and terminals represented in FIG. 1 cooperate via network communications hardware and software to initiate the collection of data for use in the SRM system, the processes involving which will now be described in more detail.

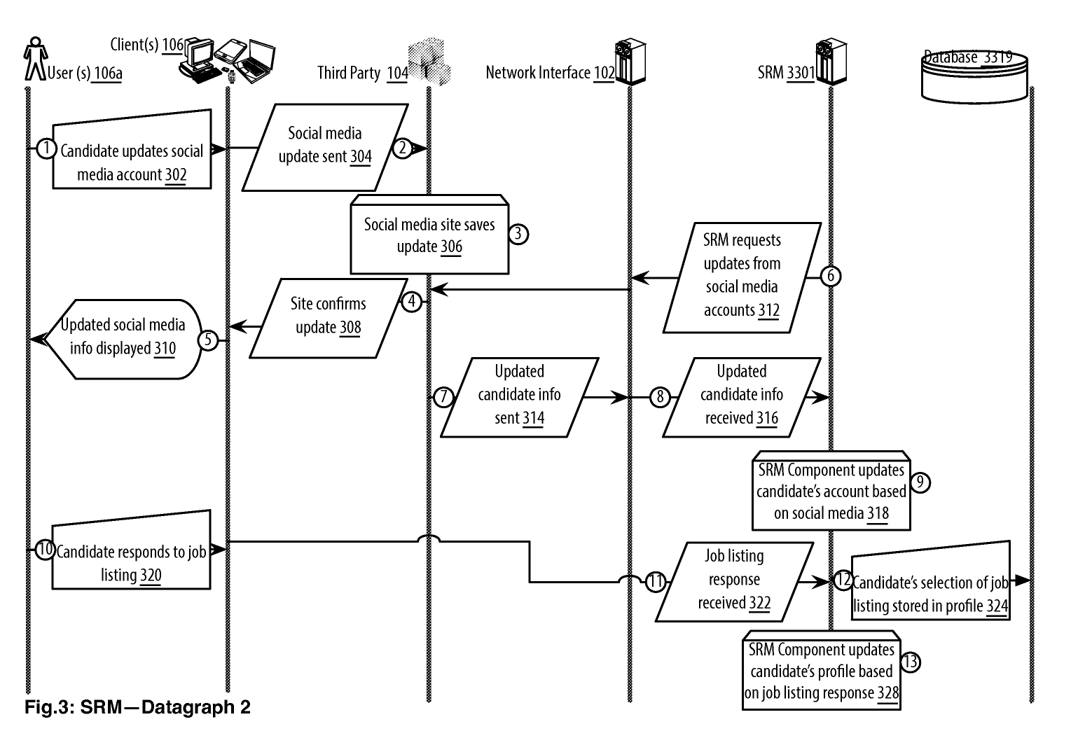

FIGS. 2-3 show a datagraph diagram illustrating embodiments of an employment candidate profile generation process for the SRM. Referring now to FIG. 2, at step 202, the process commences when an employment candidate logs into the SRM system in any of a variety of well-known manners (see, e.g., FIG. 5). The employment candidate's login credentials are next received by the SRM system (step 204) and compared to the account credentials stored by the SRM system in database 3319. In the case where the employment candidate is registered with the SRM system previously, submitted credentials are compared to the credentials stored for the employment candidate, for example, in active accounts database 3319a. In the case where the employment candidate is not registered with the SRM system, the employment candidate may first have to register in order to interact with the SRM system, as described later below.

In one embodiment, the user may provide the following example Login Request, substantially in the form of a (Secure) Hypertext Transfer Protocol (“HTTP(S)”) POST message including eXtensible Markup Language (“XML”) formatted data, as provided below:

POST /authrequest.php HTTP/1.1
Host: www.server.com
Content-Type: Application/XML
Content-Length: 667
<?XML version = “1.0” encoding = “UTF-8”?>
<auth_request>

<timestamp>2020-12-31 23:59:59</timestamp>
<user_accounts_details>

<user_account_credentials>

<user_name>JohnDaDoeDoeDoooe@gmail.com</account_name>
<password>abc123</password>
//OPTIONAL <cookie>cookieID</cookie>
//OPTIONAL <digital_cert_link>www.mydigitalcertificate.com/

JohnDoeDaDoeDoe@gmail.com/mycertifcate.dc</digital_cert_link>

//OPTIONAL <digital_certificate>_DATA_</digital_certificate>

</user_account_credentials>

</user_accounts_details>
<client_details> //iOS Client with App and Webkit

<client_IP>10.0.0.123</client_IP>
<user_agent_string>Mozilla/5.0 (iPhone; CPU iPhone OS 7_1_1 like Mac

OS X) AppleWebKit/537.51.2 (KHTML, like Gecko) Version/7.0 Mobile/11D201
Safari/9537.53</user_agent_string>

<client_product_type>iPhone6,1</client_product_type>
<client_serial_number>DNXXX1X1XXXX</client_serial_number>
<client_UDID>3XXXXXXXXXXXXXXXXXXXXXXXXD</client_UDID>
<client_OS>iOS</client_OS>
<client_OS_version>7.1.1</client_OS_version>
<client_app_type>app with webkit</client_app_type>
<app_installed_flag>true</app_installed_flag>
<app_name>SRM.app</app_name>
<app_version>1.0 </app_version>
<app_webkit_name>Mobile Safari</client_webkit_name>
<client_version>537.51.2</client_version>

</client_details>
<client_details> //iOS Client with Webbrowser

<client_IP>10.0.0.123</client_IP>
<user_agent_string>Mozilla/5.0 (iPhone; CPU iPhone OS 7_1_1 like Mac

OS X) AppleWebKit/537.51.2 (KHTML, like Gecko) Version/7.0 Mobile/11D201
Safari/9537.53</user_agent_string>

<client_product_type>iPhone6,1</client_product_type>
<client_serial_number>DNXXX1X1XXXX</client_serial_number>
<client_UDID>3XXXXXXXXXXXXXXXXXXXXXXXXD</client_UDID>
<client_OS>iOS</client_OS>
<client_OS_version>7.1.1</client_OS_version>
<client_app_type>web browser</client_app_type>
<client_name>Mobile Safari</client_name>
<client_version>9537.53</client_version>

</client_details>
<client_details> //Android Client with Webbrowser

<client_IP>10.0.0.123</client_IP>
<user_agent_string>Mozilla/5.0 (Linux; U; Android 4.0.4; en-us; Nexus

S Build/IMM76D) AppleWebKit/534.30 (KHTML, like Gecko) Version/4.0 Mobile
Safari/534.30</user_agent_string>

<client_product_type>Nexus S</client_product_type>
<client_serial_number>YXXXXXXXXZ</client_serial_number>
<client_UDID>FXXXXXXXXX-XXXX-XXXX-XXXX-XXXXXXXXXXXXX</client_UDID>
<client_OS>Android</client_OS>
<client_OS_version>4.0.4</client_OS_version>
<client_app_type>web browser</client_app_type>
<client_name>Mobile Safari</client_name>
<client_version>534.30</client_version>

</client_details>
<client_details> //Mac Desktop with Webbrowser

<client_IP>10.0.0.123</client_IP>
<user_agent_string>Mozilla/5.0 (Macintosh; Intel Mac OS X 10_9_3)

AppleWebKit/537.75.14 (KHTML, like Gecko) Version/7.0.3
Safari/537.75.14</user_agent_string>

<client_product_type>MacPro5,1</client_product_type>
<client_serial_number>YXXXXXXXXZ</client_serial_number>
<client_UDID>FXXXXXXXXX-XXXX-XXXX-XXXX-XXXXXXXXXXXXX</client_UDID>
<client_OS>Mac OS X</client_OS>
<client_OS_version>10.9.3</client_OS_version>
<client_app_type>web browser</client_app_type>
<client_name>Mobile Safari</client_name>
<client_version>537.75.14</client_version>

</client_details>
<login_data>

<adeviceType>mobile</deviceType>
<userName>johndoe</userName>
<passWord>abc123</passWord>
<loginRemember>n</loginRemember>

</login_data>

</auth_request>

Next, at step 206, upon successful verification, the employment candidate's account data is retrieved from database 3319. The candidate's account data is then sent, via Network Interface Server 102 (step 208), to the client terminal 106 via a data communications network such as the Internet (step 210). The candidates account data is then displayed to the employment candidate on a display device of the client terminal 106 (step 212).

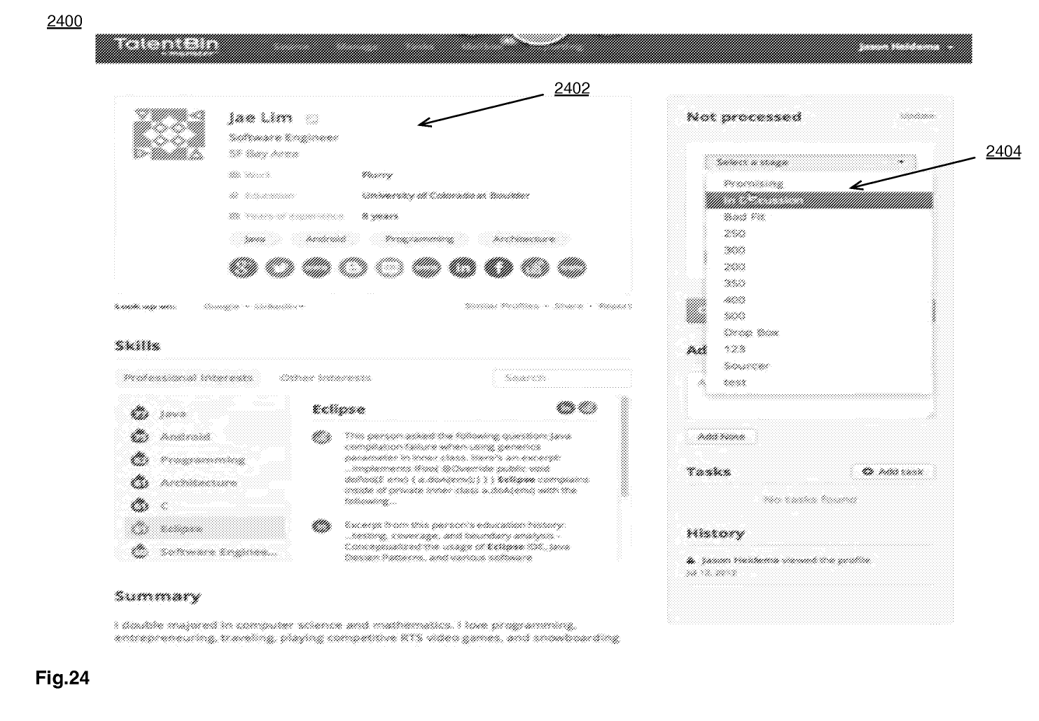

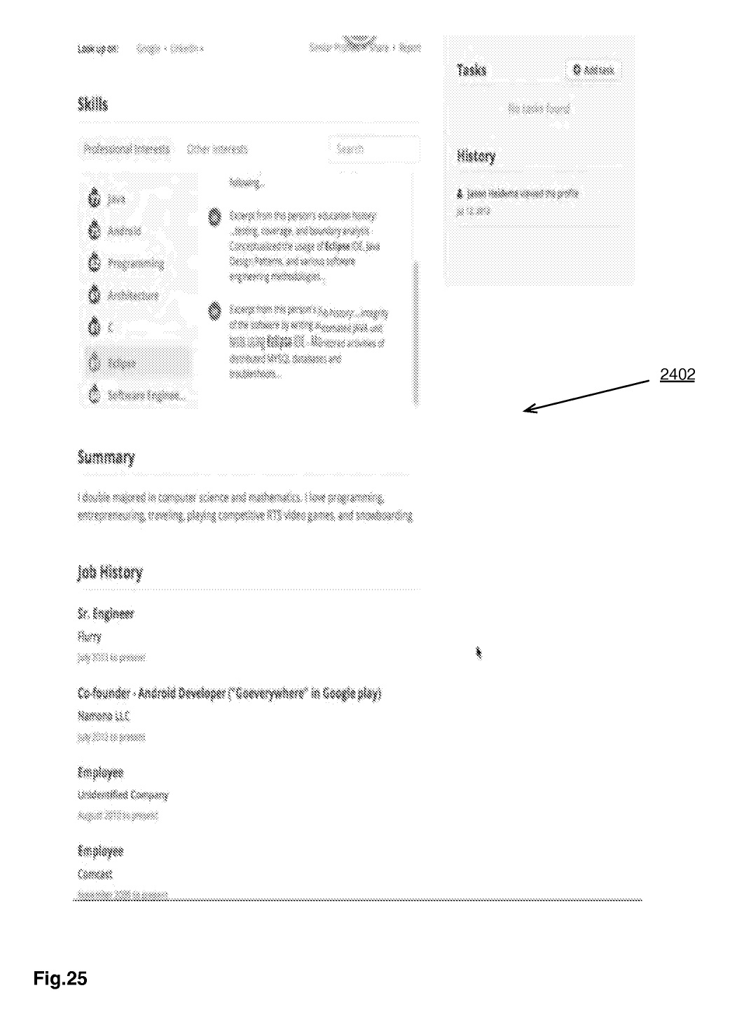

Next, at step 214, the candidate may update his/her employment history by filling in data in various fields as provided on the display. Such job information may be as that shown in FIGS. 24 and 25. The updated employment history information is then sent to the SRM the network interface server 102. The SRM processes the updated job history (step 216). The updated job history information is then stored in database 3319 (step 218).

An exemplary update to the job history of the employment candidate as stored in the SRM Database may take the following form:

<?PHP
header(′Content-Type: text/plain′);
// store input data in a database
mysql_connect(″201.408.185.132″,$DBserver,$password); // access
database server
mysql_select(″Accounts_DB.SQL″); // select database to append
mysql_query(“UPDATE JobHistoryTable
SET last_job = ‘Waiter′ , job_type = ′Food Service’,
employment_start_date =
′5/13/2014’, employment_end_date = ′present’, employer_name =
‘Acme Restaurants’, employment_location = ‘Albuquerque, NM’;
mysql_close(″Accounts_DB.SQL″); // close connection to database
?>

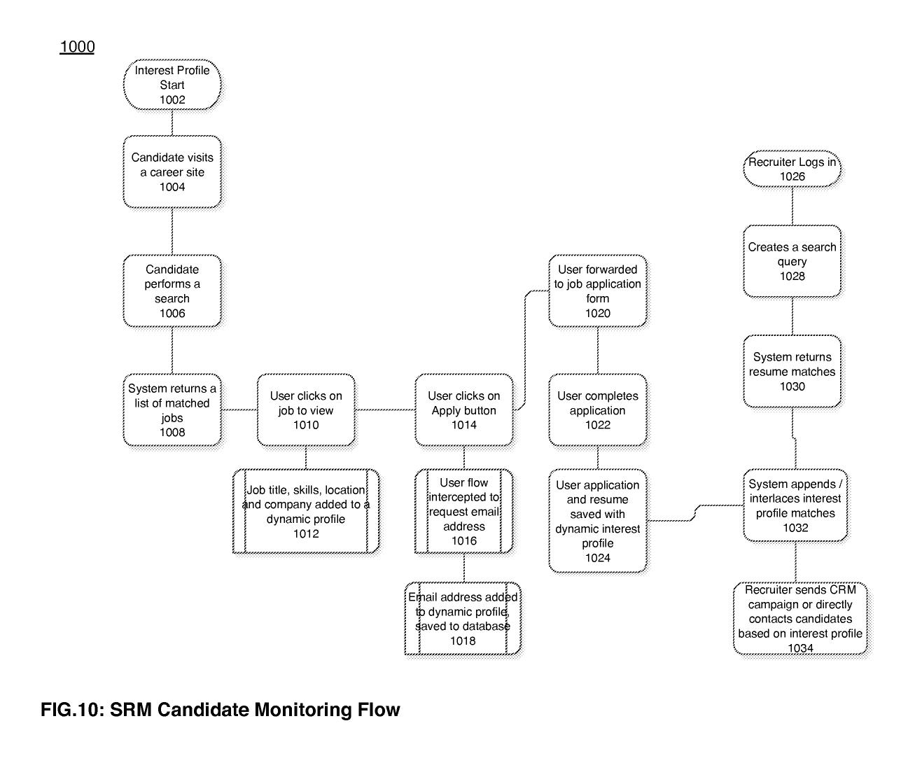

Next, at step 220, the SRM component compares the employment candidate's updated job history information to any matching available job listings stored in the SRM system (see, e.g., FIG. 10). If any matching job listings are found, the SRM component sends those job listings to the employment candidate via Network Interface Servers 102 (step 222). The updated job listings are received by the client terminal 106 (step 224) and displayed to the employment candidate on the display device of the client terminal 106 (step 226).

Referring now to FIG. 3, the process continues at step 302, where the employment candidate updates and external social media account via client terminal 106. The update may take the form of an addition to the profile or wall data of the candidate on the social media site. The social media update is sent over a data communication network to third-party social media site 104 (step 304). The third-party social media site 104 saves the update (step 306) and a confirmation of the update is sent to the employment candidate (step 308), which is then displayed to the candidate on a display device of the client terminal 106 (step 310).

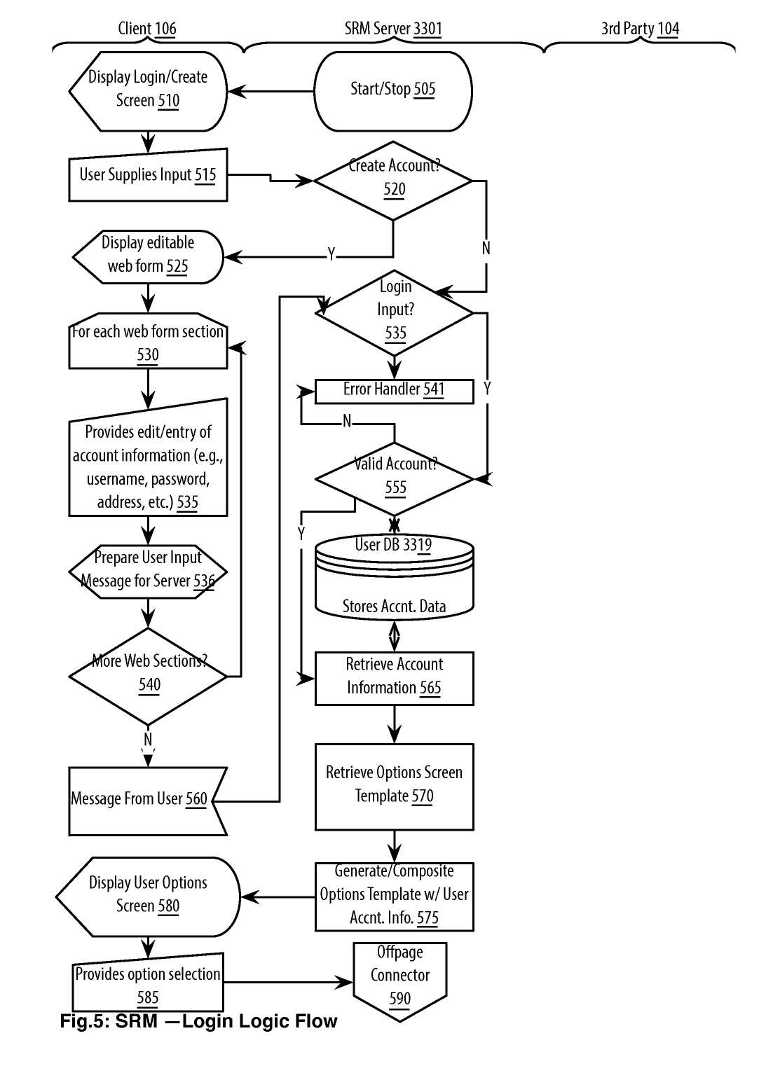

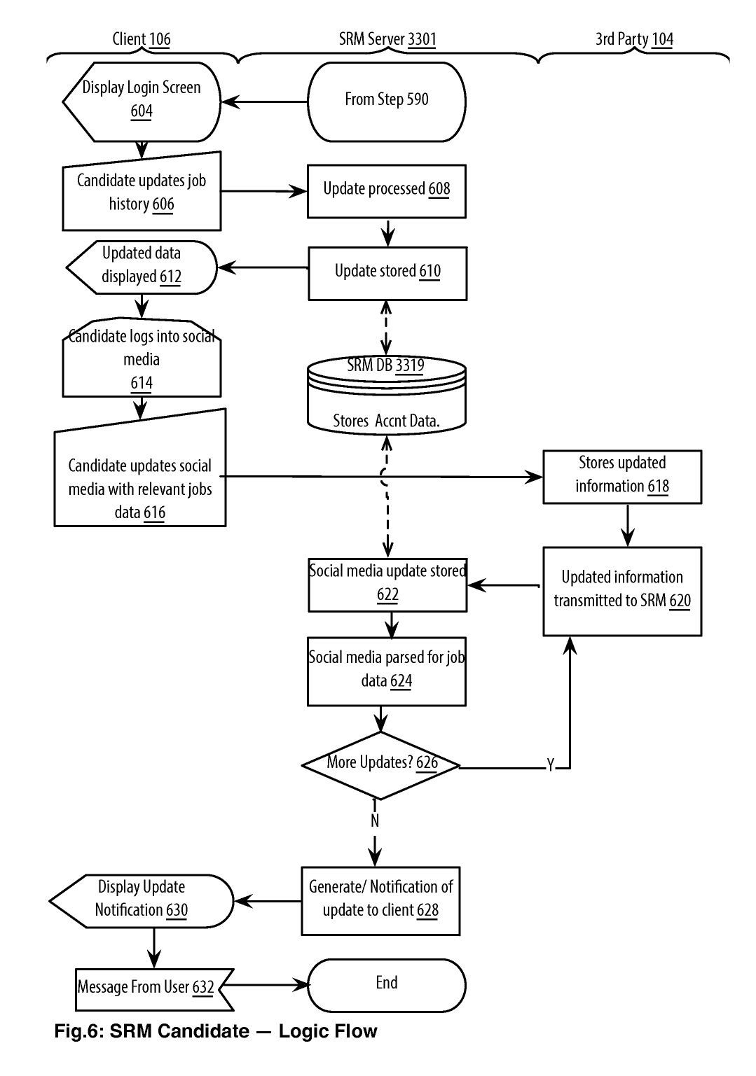

Next, or at some later time, the updated social media information of the employment candidate is sent from third-party servers 104 to the SRM via Network Interface Server(s) 102 (step 314). The update may be generated in response to an automated or periodic request by the SRM 3301 for the candidate's current social media site information. The update social media information is then received by the SRM (step 316), which in turn, parses the social media information for any job-related information (see, e.g., FIG. 6) and stores any determined job-related information in the SRM's account profile of the employment candidate (step 318). Such data may be stored in, for example, the active accounts database 3319a.

Next, or at some later time, the employment candidate may respond to a job listing posted by the SRM on behalf of an employment recruiter (step 320). The response is transmitted via Network Interface server(s) 102 and then received by the SRM 3301 (step 322).

In one embodiment, the candidate may provide the following example response to job positing, substantially in the form of a (Secure) Hypertext Transfer Protocol (“HTTP(S)”) POST message including eXtensible Markup Language (“XML”) formatted data, as provided below:

POST /authrequest.php HTTP/1.1
Host: www.server.com
Content-Type: Application/XML
Content-Length: 667
<?XML version = “1.0” encoding = “UTF-8”?>
<auth_request>

<timestamp>2020-12-31 23:59:59</timestamp>
<user_accounts_details>

<user_account_credentials>

<user_name>JohnDaDoeDoeDoooe@gmail.com</account_name>
<password>abc123</password>
//OPTIONAL <cookie>cookieID</cookie>
//OPTIONAL <digital_cert_link>www.mydigitalcertificate.com/

JohnDoeDaDoeDoe@gmail.com/mycertifcate.dc</digital_cert_link>

//OPTIONAL <digital_certificate>_DATA_</digital_certificate>

</user_account_credentials>

</user_accounts_details>
<client_details> //iOS Client with App and Webkit

<client_IP>10.0.0.123</client_IP>
<user_agent_string>Mozilla/5.0 (iPhone; CPU iPhone OS 7_1_1 like Mac

OS X) AppleWebKit/537.51.2 (KHTML, like Gecko) Version/7.0 Mobile/11D201
Safari/9537.53</user_agent_string>

<client_product_type>iPhone6,1</client_product_type>
<client_serial_number>DNXXX1X1XXXX</client_serial_number>
<client_UDID>3XXXXXXXXXXXXXXXXXXXXXXXXD</client_UDID>
<client_OS>iOS</client_OS>
<client_OS_version>7.1.1</client_OS_version>
<client_app_type>app with webkit</client_app_type>
<app_installed_flag>true</app_installed_flag>
<app_name>SRM.app</app_name>
<app_version>1.0 </app_version>
<app_webkit_name>Mobile Safari</client_webkit_name>
<client_version>537.51.2</client_version>

</client_details>
<client_details> //iOS Client with Webbrowser

<client_IP>10.0.0.123</client_IP>
<user_agent_string>Mozilla/5.0 (iPhone; CPU iPhone OS 7_1_1 like Mac

OS X) AppleWebKit/537.51.2 (KHTML, like Gecko) Version/7.0 Mobile/11D201
Safari/9537.53</user_agent_string>

<client_product_type>iPhone6,1</client_product_type>
<client_serial_number>DNXXX1X1XXXX</client_serial_number>
<client_UDID>3XXXXXXXXXXXXXXXXXXXXXXXXD</client_UDID>
<client_OS>iOS</client_OS>
<client_OS_version>7.1.1</client_OS_version>
<client_app_type>web browser</client_app_type>
<client_name>Mobile Safari</client_name>
<client_version>9537.53</client_version>

</client_details>
<client_details> //Android Client with Webbrowser

<client_IP>10.0.0.123</client_IP>
<user_agent_string>Mozilla/5.0 (Linux; U; Android 4.0.4; en-us; Nexus

S Build/IMM76D) AppleWebKit/534.30 (KHTML, like Gecko) Version/4.0 Mobile
Safari/534.30</user_agent_string>

<client_product_type>Nexus S</client_product_type>
<client_serial_number>YXXXXXXXXZ</client_serial_number>
<client_UDID>FXXXXXXXXX-XXXX-XXXX-XXXX-XXXXXXXXXXXXX</client_UDID>
<client_OS>Android</client_OS>
<client_OS_version>4.0.4</client_OS_version>
<client_app_type>web browser</client_app_type>
<client_name>Mobile Safari</client_name>
<client_version>534.30</client_version>

</client_details>
<client_details> //Mac Desktop with Webbrowser

<client_IP>10.0.0.123</client_IP>
<user_agent_string>Mozilla/5.0 (Macintosh; Intel Mac OS X 10_9_3)

AppleWebKit/537.75.14 (KHTML, like Gecko) Version/7.0.3
Safari/537.75.14</user_agent_string>

<client_product_type>MacPro5,1</client_product_type>
<client_serial_number>YXXXXXXXXZ</client_serial_number>
<client_UDID>FXXXXXXXXX-XXXX-XXXX-XXXX-XXXXXXXXXXXXX</client_UDID>
<client_OS>Mac OS X</client_OS>
<client_OS_version>10.9.3</client_OS_version>
<client_app_type>web browser</client_app_type>
<client_name>Mobile Safari</client_name>
<client_version>537.75.14</client_version>

</client_details>
<job_application_request>

<candidateID>1231123</candidateID>
<campaignNo>TB125</camaignNo>

</job_application_request>

</auth_request>

The candidate's selection of and interest in a particular job listing is then stored in the employment candidate's profile as maintained by the SRM 3301, such as in active accounts database 3319a (step 324).

An exemplary update to the profile of the employment candidate as stored in the SRM Database may take the following form:

<?PHP
header(′Content-Type: text/plain′);
// store input data in a database
mysql_connect(″201.408.185.132″,$DBserver,$password); // access
database server
mysql_select(″Accounts_DB.SQL″); // select database to append
mysql_query(“UPDATE interestProfileTable
SET candidateID = ‘1231123′ , activity_date = ′5/13/2014’,
activity_type = ′jobapplication request’, campaignID = ′TB125’;
mysql_close(″Accounts_DB.SQL″); // close connection to database
?>

Finally, the SRM 3301 updates the employment candidate profile (see FIG. 10) based on the interest in the job listing demonstrated by the employment candidate (step 326). This may be accomplished, for example, by updating a pre-formatted résumé established for the employment candidate by the SRM 3301 with the job-related information parsed from the social media information of the employment candidate, in an appropriate section of the résumé. This instance of the employment candidate profile generation process for the SRM then ends.

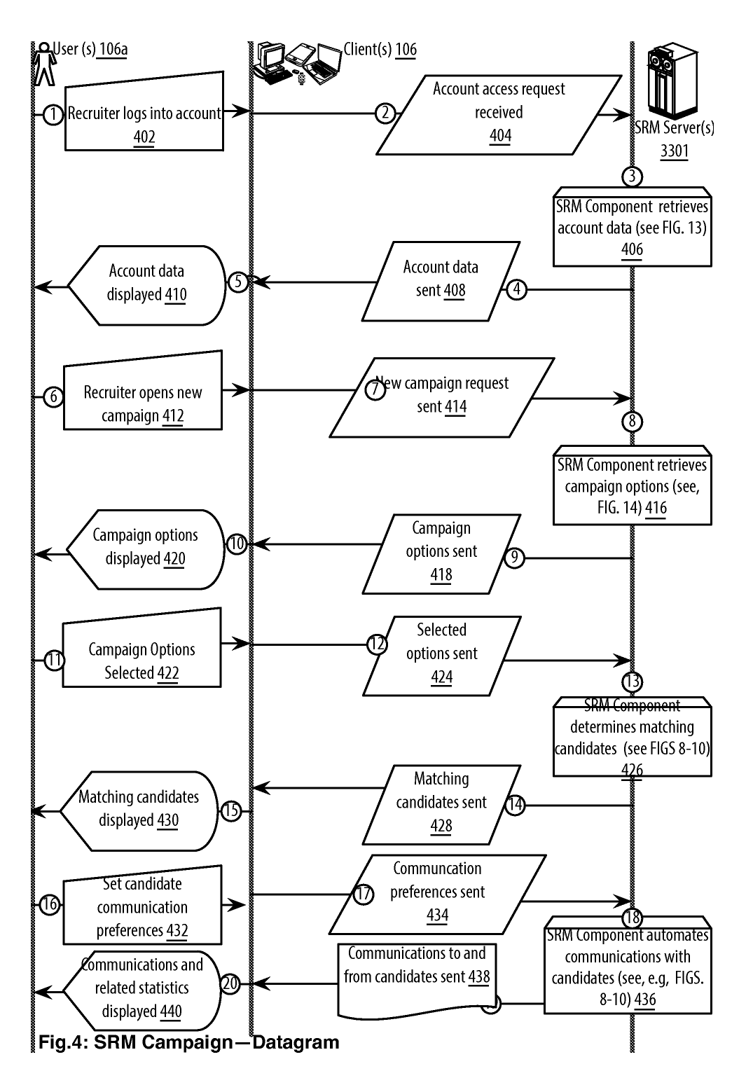

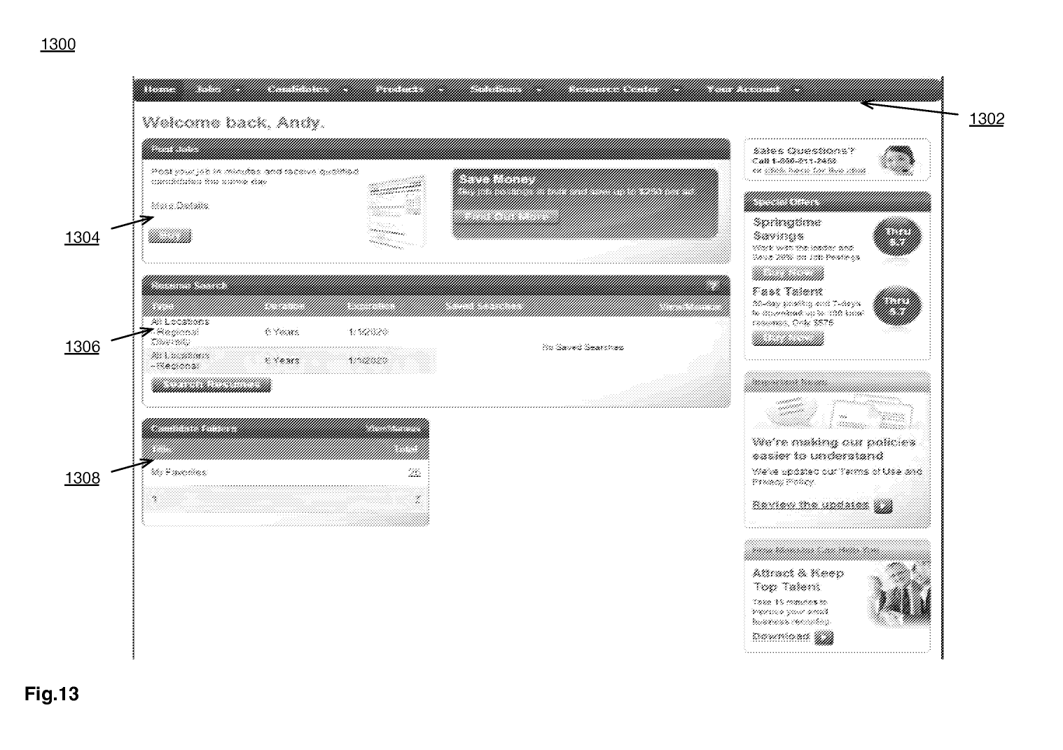

FIG. 4 shows a datagraph diagram illustrating embodiments of a recruiting campaign establishment process for the SRM. Commencing at step 402, an employment recruiter may log into the SRM 3301 in order to create an employment recruiting campaign or to review the status of an existing campaign, as may be associated with the recruiter's SRM account. The recruiter's login credentials are received and verified by the SRM (step 404). Responsive to the verification, the SRM retrieves the recruiter's account data (step 406), which is then sent to the client terminal 106 of the recruiter (step 408), where it is displayed to the recruiter on a display device thereof (step 410). At this point, the recruiter may also be presented with options to create a new recruiting campaign or viewing existing campaigns (see, e.g., FIG. 13).

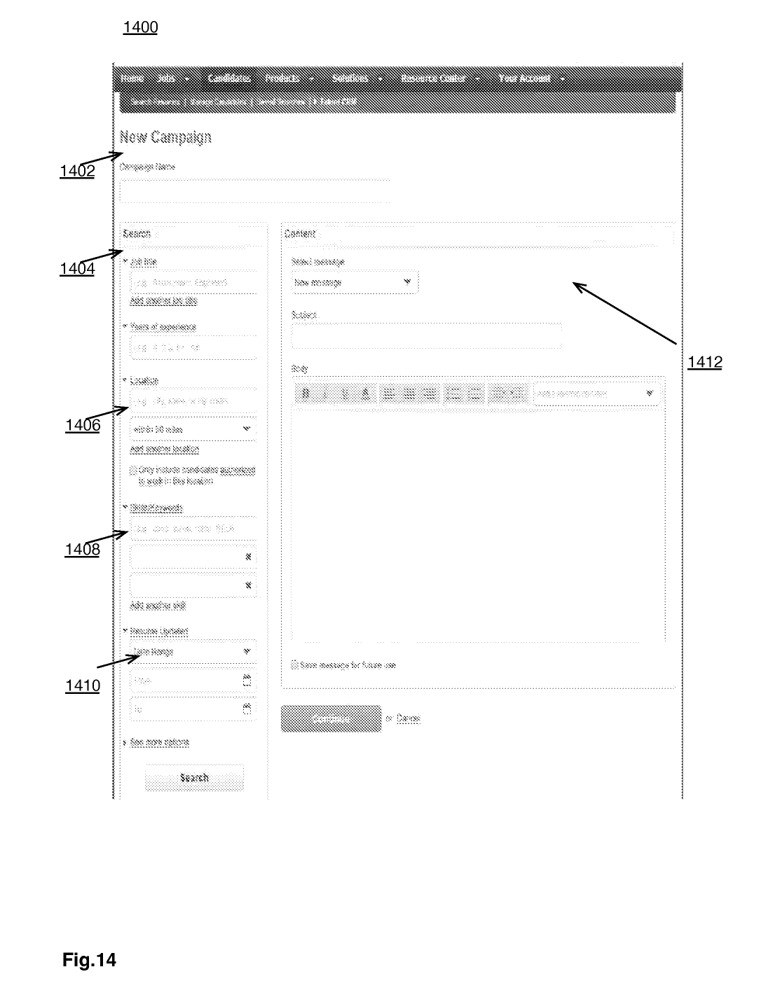

At step 412, the recruiter requests to establish a new recruiting campaign via client terminal 106. The new campaign request is then sent to the SRM 3301 over a data communications network (step 414). Responsive thereto, the SRM 3301 retrieves campaign options that are to be selected by the recruiter (step 416). The campaign options are sent to the client terminal 106 (step 418) and displayed to the recruiter on a display device of the client terminal 106 (step 420). An example of various recruiting campaign options to be selected is displayed in, and described in more detail with respect to, FIG. 14. In general, the campaign options may include an available job position, a location of the job, and the desired qualifications of any candidates for the available job position.

Next, at step 422, the recruiter selects various campaign options, which are then sent from client terminal 106 to the SRM 3301 (step 424).

In one embodiment, the recruiter may provide the following example campaign options selection, substantially in the form of a (Secure) Hypertext Transfer Protocol (“HTTP(S)”) POST message including eXtensible Markup Language (“XML”) formatted data, as provided below:

POST /authrequest.php HTTP/1.1
Host: www.server.com
Content-Type: Application/XML
Content-Length: 667
<?XML version = “1.0” encoding = “UTF-8”?>
<auth_request>

<timestamp>2020-12-31 23:59:59</timestamp>
<user_accounts_details>

<user_account_credentials>

<user_name>JohnDaDoeDoeDoooe@gmail.com</account_name>
<password>abc123</password>
//OPTIONAL <cookie>cookieID</cookie>
//OPTIONAL <digital_cert_link>www.mydigitalcertificate.com/

JohnDoeDaDoeDoe@gmail.com/mycertifcate.dc</digital_cert_link>

//OPTIONAL <digital_certificate>_DATA_</digital_certificate>

</user_account_credentials>

</user_accounts_details>
<client_details> //iOS Client with App and Webkit

<client_IP>10.0.0.123</client_IP>
<user_agent_string>Mozilla/5.0 (iPhone; CPU iPhone OS 7_1_1 like Mac

OS X) AppleWebKit/537.51.2 (KHTML, like Gecko) Version/7.0 Mobile/11D201
Safari/9537.53</user_agent_string>

<client_product_type>iPhone6,1</client_product_type>
<client_serial_number>DNXXX1X1XXXX</client_serial_number>
<client_UDID>3XXXXXXXXXXXXXXXXXXXXXXXXD</client_UDID>
<client_OS>iOS</client_OS>
<client_OS_version>7.1.1</client_OS_version>
<client_app_type>app with webkit</client_app_type>
<app_installed_flag>true</app_installed_flag>
<app_name>SRM.app</app_name>
<app_version>1.0 </app_version>
<app_webkit_name>Mobile Safari</client_webkit_name>
<client_version>537.51.2</client_version>

</client_details>
<client_details> //iOS Client with Webbrowser

<client_IP>10.0.0.123</client_IP>
<user_agent_string>Mozilla/5.0 (iPhone; CPU iPhone OS 7_1_1 like Mac

OS X) AppleWebKit/537.51.2 (KHTML, like Gecko) Version/7.0 Mobile/11D201
Safari/9537.53</user_agent_string>

<client_product_type>iPhone6,1</client_product_type>
<client_serial_number>DNXXX1X1XXXX</client_serial_number>
<client_UDID>3XXXXXXXXXXXXXXXXXXXXXXXXD</client_UDID>
<client_OS>iOS</client_OS>
<client_OS_version>7.1.1</client_OS_version>
<client_app_type>web browser</client_app_type>
<client_name>Mobile Safari</client_name>
<client_version>9537.53</client_version>

</client_details>
<client_details> //Android Client with Webbrowser

<client_IP>10.0.0.123</client_IP>
<user_agent_string>Mozilla/5.0 (Linux; U; Android 4.0.4; en-us; Nexus

S Build/IMM76D) AppleWebKit/534.30 (KHTML, like Gecko) Version/4.0 Mobile
Safari/534.30</user_agent_string>

<client_product_type>Nexus S</client_product_type>
<client_serial_number>YXXXXXXXXZ</client_serial_number>
<client_UDID>FXXXXXXXXX-XXXX-XXXX-XXXX-XXXXXXXXXXXXX</client_UDID>
<client_OS>Android</client_OS>
<client_OS_version>4.0.4</client_OS_version>
<client_app_type>web browser</client_app_type>
<client_name>Mobile Safari</client_name>
<client_version>534.30</client_version>

</client_details>
<client_details> //Mac Desktop with Webbrowser

<client_IP>10.0.0.123</client_IP>
<user_agent_string>Mozilla/5.0 (Macintosh; Intel Mac OS X 10_9_3)

AppleWebKit/537.75.14 (KHTML, like Gecko) Version/7.0.3
Safari/537.75.14</user_agent_string>

<client_product_type>MacPro5,1</client_product_type>
<client_serial_number>YXXXXXXXXZ</client_serial_number>
<client_UDID>FXXXXXXXXX-XXXX-XXXX-XXXX-XXXXXXXXXXXXX</client_UDID>
<client_OS>Mac OS X</client_OS>
<client_OS_version>10.9.3</client_OS_version>
<client_app_type>web browser</client_app_type>
<client_name>Mobile Safari</client_name>
<client_version>537.75.14</client_version>

</client_details>
<campaign_initiation_request>

<recruiterID>TB125</candidateID>
<campaignName>Software Programmer Needed</camaignNo>
<jobTitle>Web Developer</jobTitle>
<location>Princeton, NJ</location>
<primaryJobSkill>JAVASCRIPT</primaryJobSkill>
<secondaryJobSkill>C++</secondaryJobSkill>
<salary>55,000</salary>

</ campaign_initiation_request >

</auth_request>

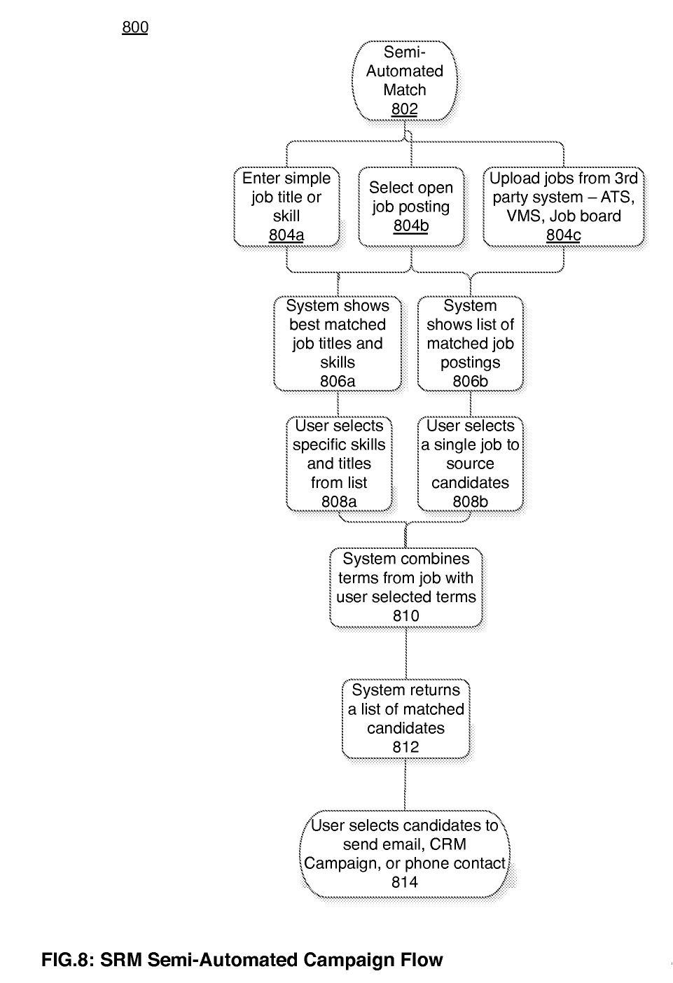

Responsive thereto, the SRM determines whether the profiles of any existing active or inactive employment candidates match the requirements of the recruiting campaign established by the recruiter via the campaign options selection above (step 426). Various processes for accomplishing this step by the SRM are further described below with respect to FIGS. 8-10. Exemplary programming instructions for accomplishing this are as follows:

fuction checkAllFields( )
{

urlString = “&”;

for(i=0; i<document.sixSenseSearchForm.elements.length; i++)
{

if (document.sixSenseSearchForm.elements[i].name != “cfval”
&& document.sixSenseSearchForm.elements[i].name != “cfid”

&&

document.sixSenseSearchForm.elements[i].name != “search” )

{

if

(document.sixSenseSearchForm.elements[i].value.length >0 )

{

urlString +=

document.sixSenseSearchForm.elements[i].name +“=”;

urlString +=

encodeURIComponent(encodeURIComponent(document.sixSenseSearchForm.elements[i].v
alue));

if(document.sixSenseSearchForm.elements[i].name != “sk”)

urlString += “&”;

else

urlString += “+nth&”;

}

}

}

if (document.sixSenseSearchForm.cfval.value.length > 0 )

urlString += “cf” + document.sixSenseSearchForm.cfid.value + “=” +

document.sixSenseSearchForm.cfval.value ;
mhxUrl =
‘http://hiring.monster.com/jcm/resumesearch/EnhancedSearchResults.aspx?seng=tro
vix&’ + urlString;
getSeeMoreResults(“http://prdbx.monster.com/query.ashx?co=US&pagesize=30&” +
urlString);
}
function getSeeMoreResults(urlRequest)
{

xmlhttp.open(“GET”,urlRequest,false); // get matching

candidates from server

results +=

xmlDoc.getElementsByTagName(“Resumes”)[0].attributes.getNamedItem(“Found”).valu
e;

// loop through each candidate in the result

xmlDoc.getElementsByTagName(“PersonalData”)[j];
// get personal data - name, relevance score,

location, recent jobs etc. for each candidate

```
  //end loop
  If(!automated)
```

{

document.getElementById(‘resultsXML’).innerHTML

=results; // pass results on to page

window.location.replace(‘#resumeResults’);
} else {

sendSeeMoreMatchEmails(xmlDoc);

}

}

When matching employment candidates are found, an identification of the matching candidates is sent to the recruiter by the SRM 3301 (step 428) and are displayed to the recruiter on a display device of the client terminal 106 (step 430).

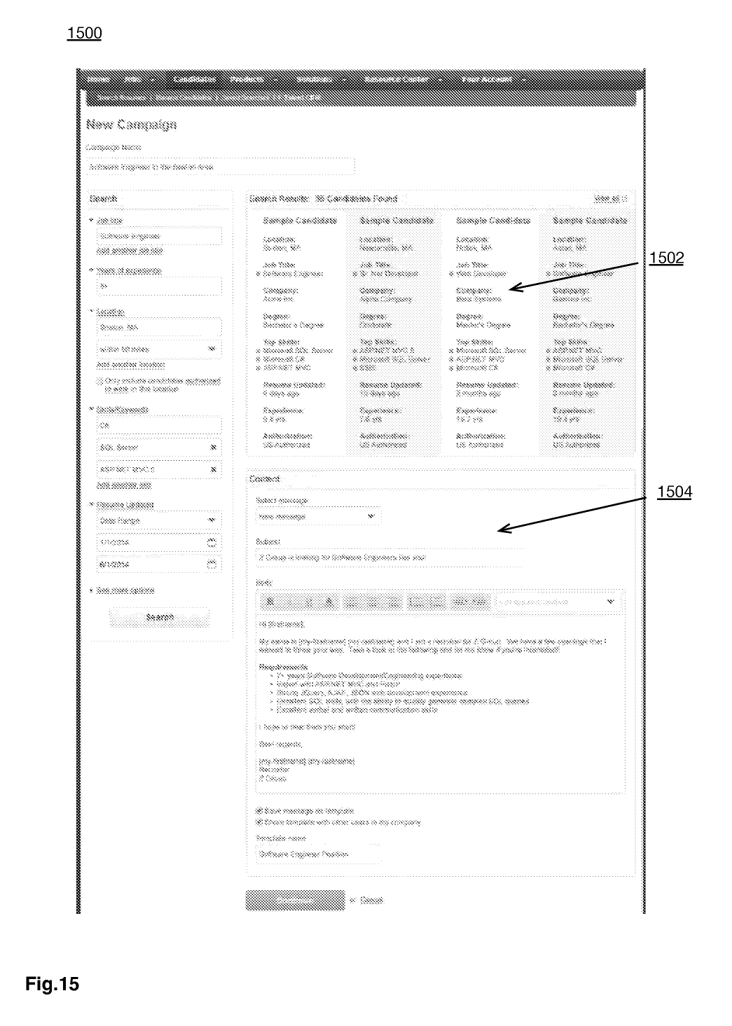

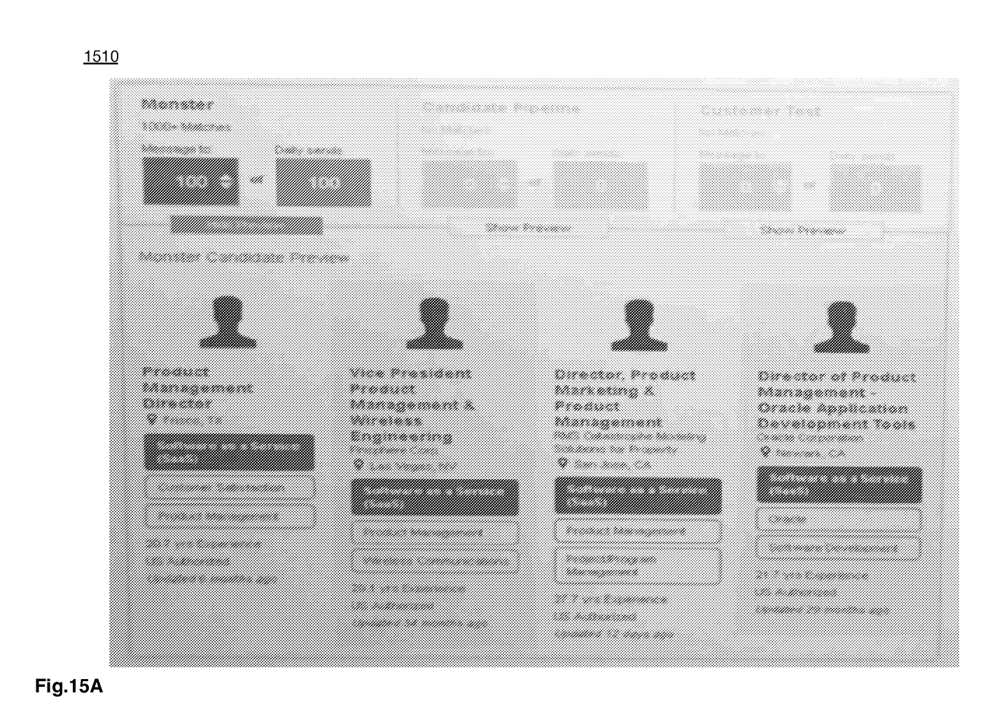

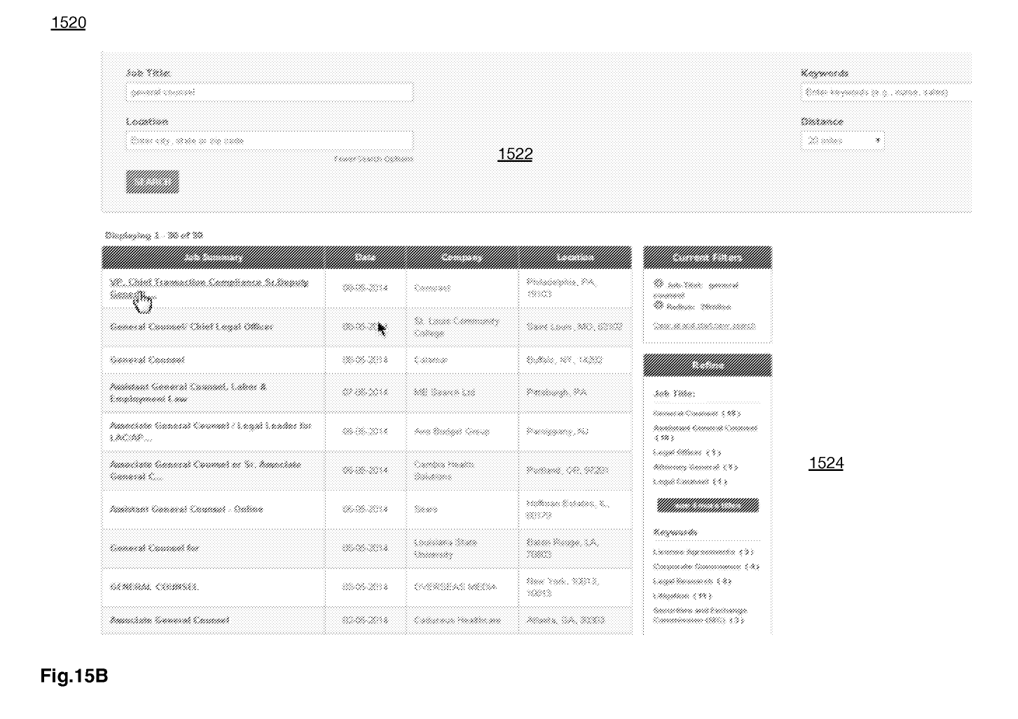

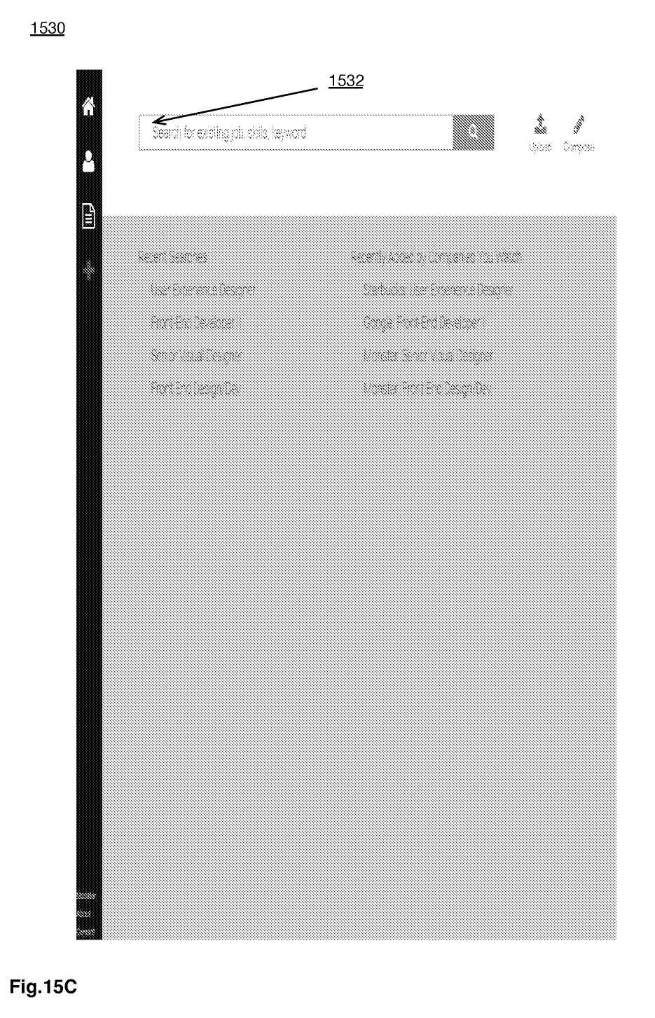

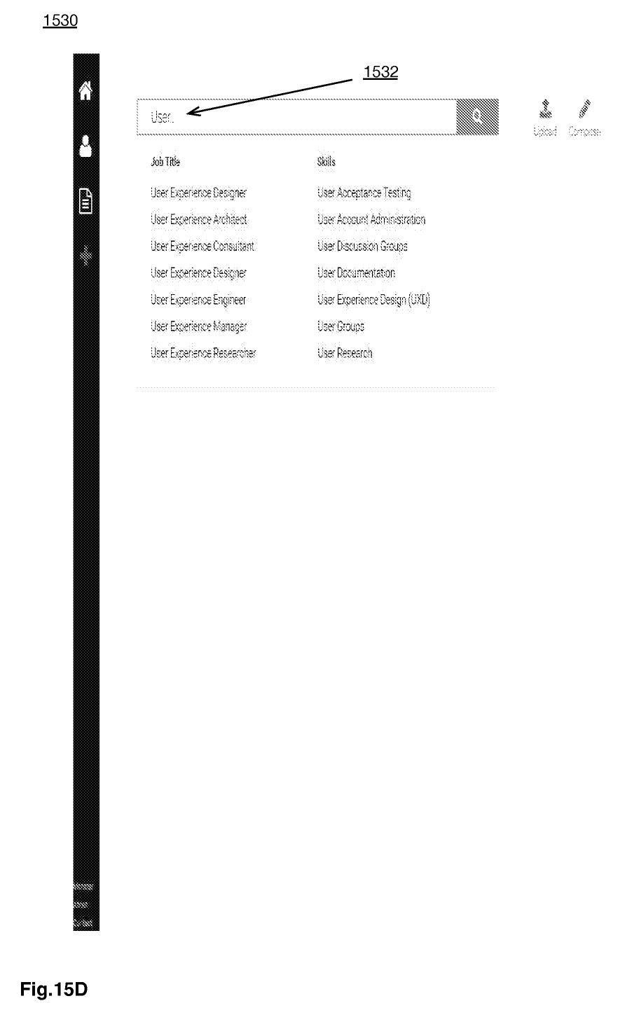

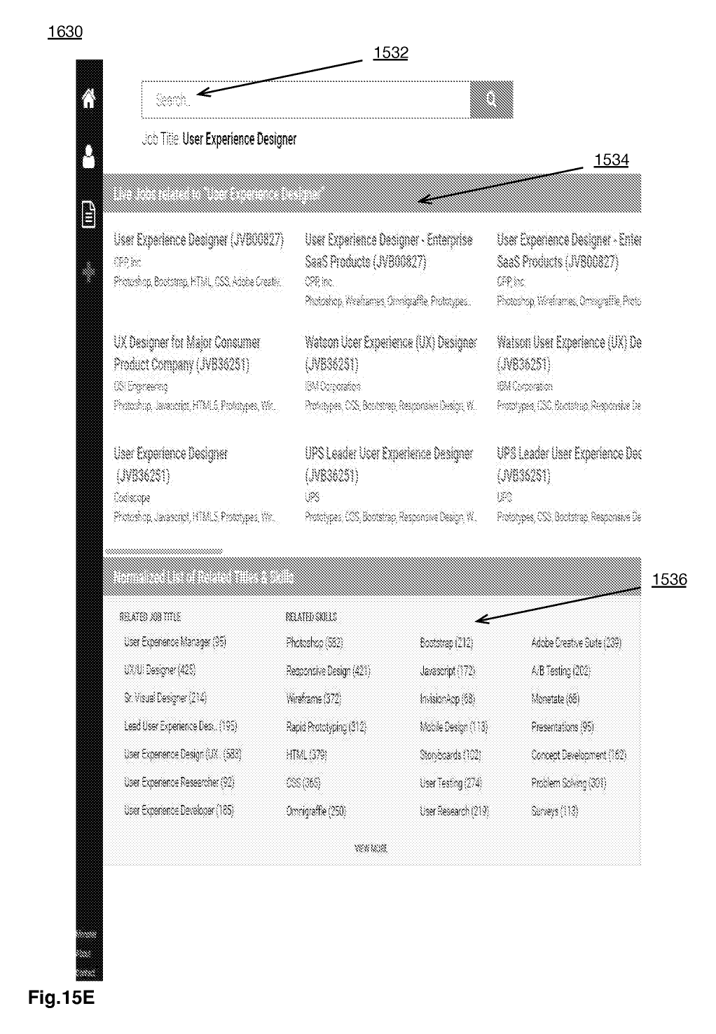

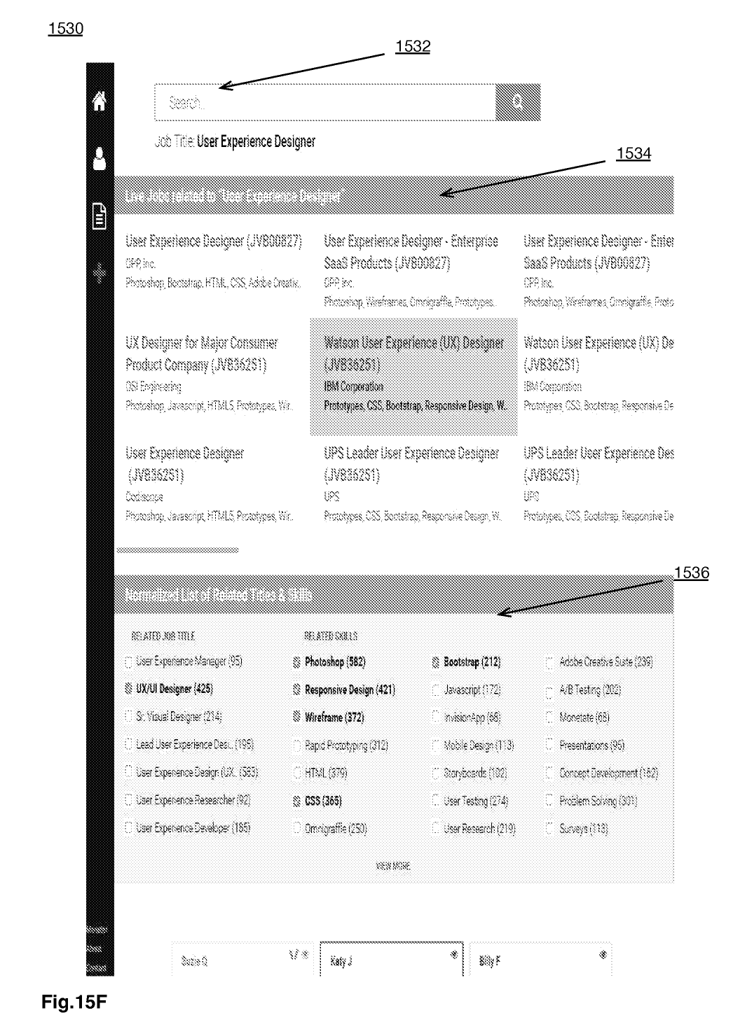

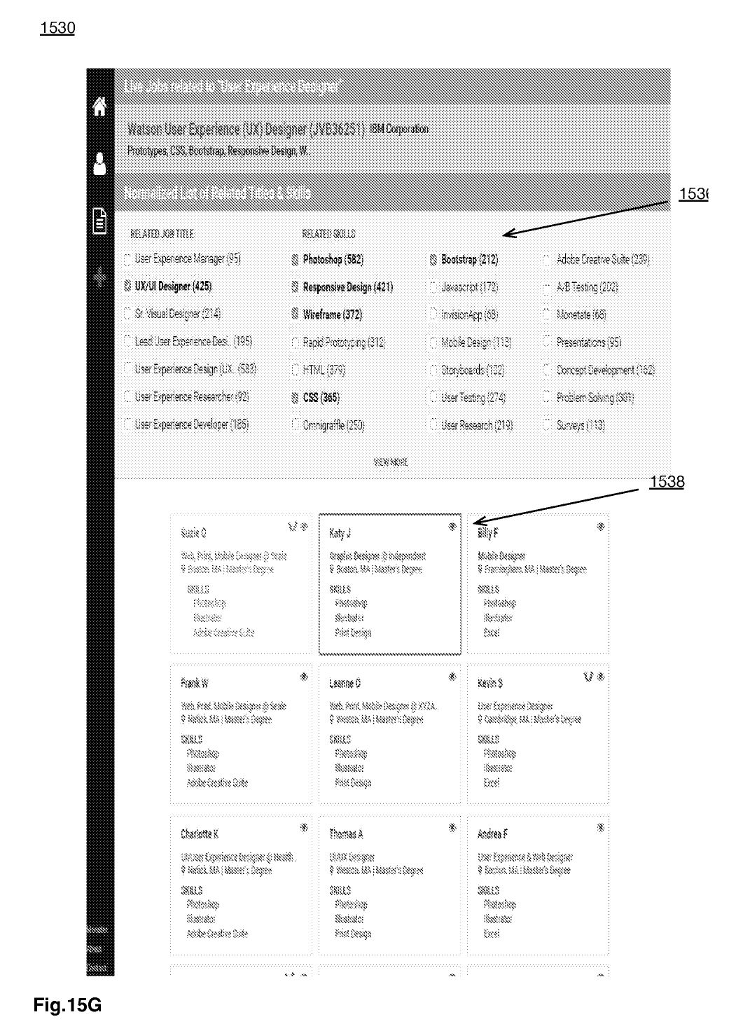

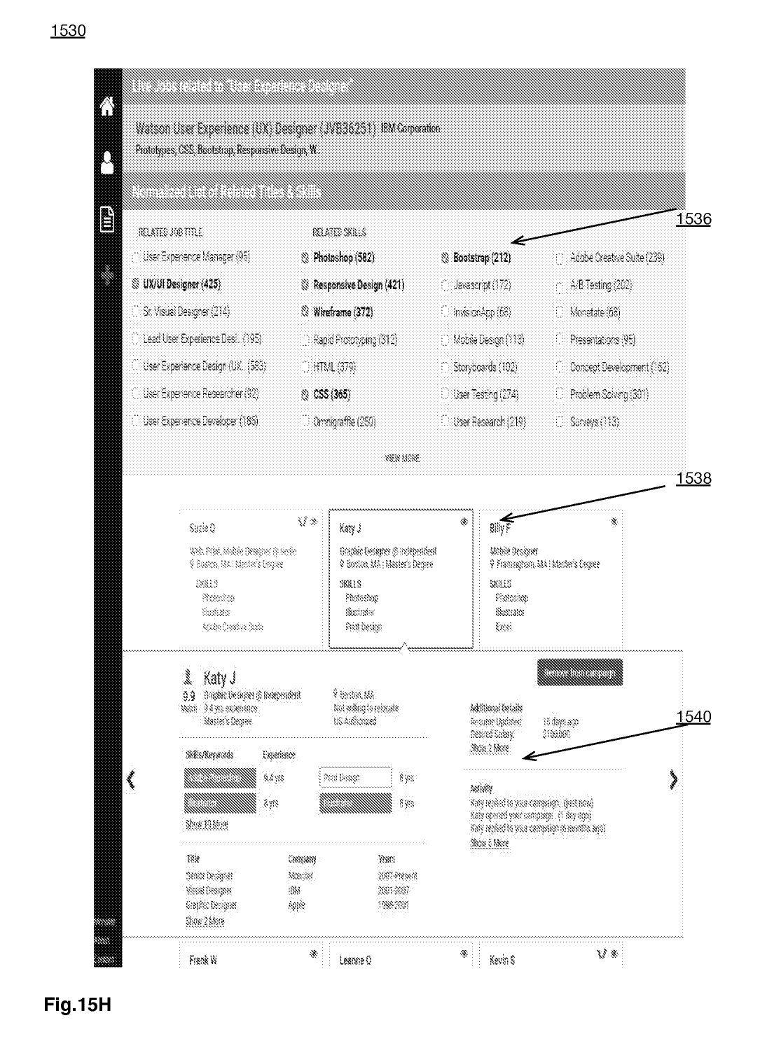

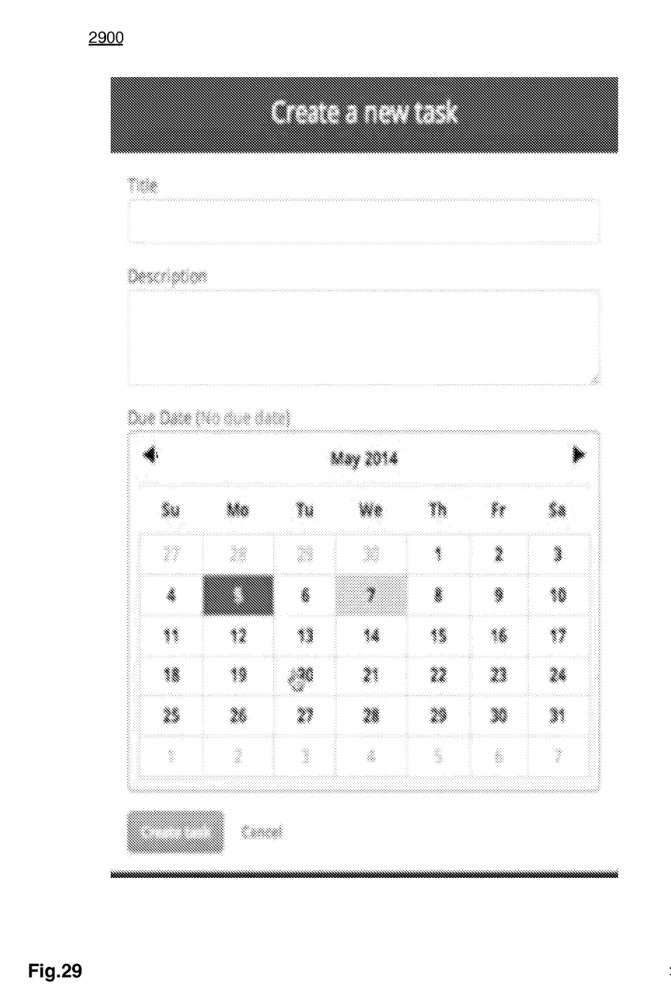

The recruiter may then designate various candidates as acceptable and establish communication preferences for notifying the various acceptable candidates of the job position available from the recruiter's campaign (step 432). The communication preferences may include a format of a first notification to be sent to the candidate(s) (see FIGS. 14 and 15), and a schedule of follow-up notifications to the acceptable employment candidates (see, e.g., FIG. 29). These communication preferences are then sent to the SRM 3301 by the client terminal 106 (step 434). Responsive thereto, the SRM automates the communications from the recruiter to the employment candidate(s) in accordance with the recruiter's established preferences (step 436). The automated communications may include: generating and sending a follow-up message to contacted candidates within a selected number of days, pinging candidates that did not respond to a campaign communication or outreach within a determined number of days of initial outreach, responding to a candidate communication received from an employment candidate in response to a campaign within a predetermined time, and/or establishing a recurrence for a campaign periodically.

Exemplary programming instructions for accomplishing step 436 is as follows:

function sendSeeMoreMatchEmails(xmlDoc)
{

// loop through each candidate in the result, up to a max of 10

candidates

xmlDoc.getElementsByTagName(“PersonalData”)[j];
// get personal data - name, relevance score,

location, recent jobs etc. for each candidate

// send personalized email to each candidate

//end loop

}

Next, or at a later time, any communications sent to and/or received from the employment candidates as part of the recruiting campaign are sent to the client terminal 106 (step 438) and displayed to the recruiter on a display device thereof (step 440). In various embodiments, communications statistics, such as candidate response rates, are tracked by the SRM and may be communicated to the recruiter as well. This instance of the recruiting campaign establishment process may then end.

FIGS. 5-7 show a logic flow diagram illustrating embodiments of an employment candidate and recruiting campaign matching process for the SRM. Referring first to FIG. 5, commencing at step 505, the SRM 3301 responds to a user's (i.e. a recruiter's or candidate's) login request and displays a login/create account screen on the Client Terminal 106 (step 510). The user responsively enters an input (step 515) comprising either a login request to an existing account, or a request to create a new account. At step 520, if the user is requesting to create an account, the process continues to step 525 below. If instead, the user is requesting access to an existing account, the process continues to step 535 below.

When the user's entry comprises a request to create a new account, the SRM 3301 prepares and transmits a web form and fields for creating a new investment account (step 525).

Next, at step 530, the user enters any requisite information in the displayed web form fields. Such web form may include fields for entering the user's name, address, contact information, a username, a password and/or any other useful identification information to associate with the recruiter or candidate account (step 535). The user's inputs are then prepared for transmission to the SRM Controller 3301 (step 536). The Client Terminal 106 confirms whether there are more web sections or forms to complete (step 540). If so, the process returns to step 530 above. Otherwise, the process continues to step 560, where the entered account information is transmitted to the SRM Controller 3301 for storage in, for example, the maintained Account Database 3319a, as described in more detail later below.

From either step 520 or 560 above, the process continues to step 535, wherein the SRM Controller 3301 determines whether a login input has been received. If so, the process continues to step 555 below. Otherwise, the process continues to an error handling routine (step 541), wherein the user may be given a limited number of attempts to enter a login input that corresponds to a valid stored investment account. If no valid login is presented within the given number of allowed attempts, the user is denied access to the SRM Controller 3301.

At step 553, the SRM Controller 3301 determines whether a valid login input has been received, for example by comparing the received login input to data stored in the SRM Database 3319. If the received login credentials are valid, the process continues to step 565 below. Otherwise the process 500 returns to step 541 above.

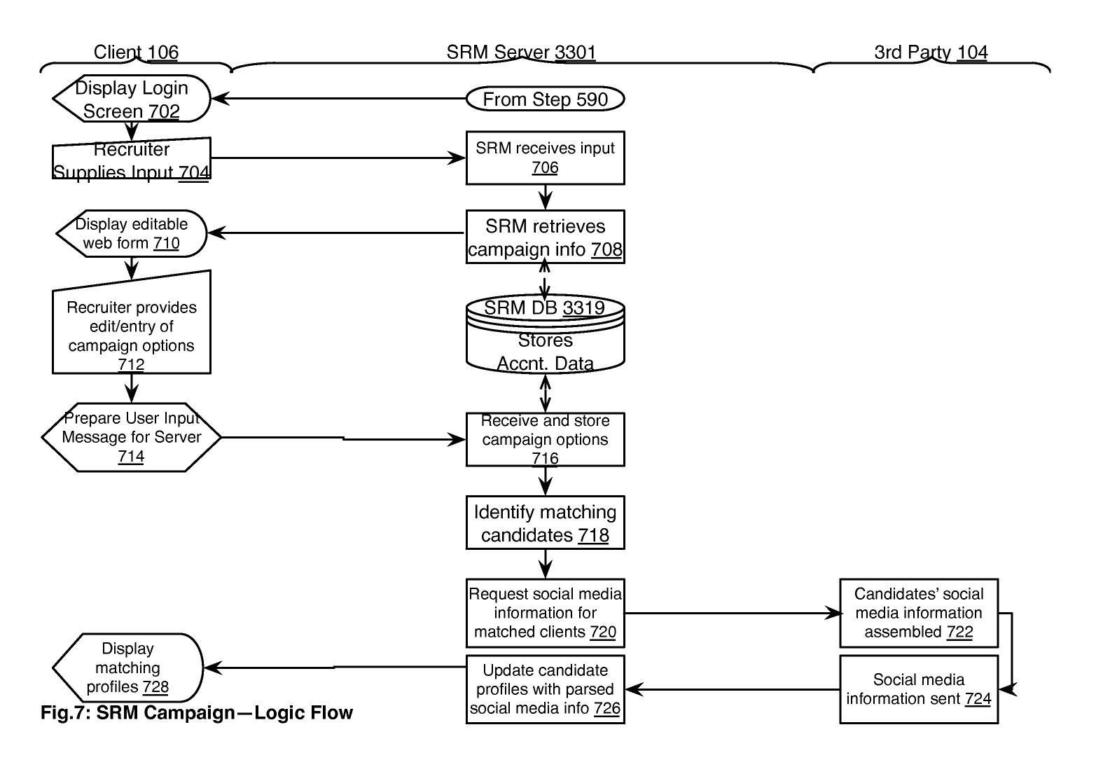

At step 565, when valid login credentials have been received from the Client Terminal 106, the SRM Controller retrieves account information appropriate for the user (i.e., based on whether the user is an employment candidate or a recruiter). Next, at step 570, the SRM 3301 retrieves an options screen template based on the user, and then generates a composite options screen with the user's account information (step 575), which is transmitted to the client terminal 106 for display to a user on a display device thereof (step 580). In response, the user provides one or more options selections to the displayed options screen (step 585). The process then continues for an employment candidate with the steps described below with respect to FIG. 6. Alternatively, the process continues for a recruiter with the steps described below with respect to FIG. 7.

Turning to FIG. 6, the employment candidate and recruiting campaign matching process continues, in the case where the user is an employment candidate to step 604, where the employment candidate's account screen is displayed to the candidate. The candidate may then update his job or employment history (step 606). The update is processed by the SRM (step 608) and stored by the SRM in SRM Database 3319 (step 610). A confirmation of the updated data may then be displayed to the employment candidate on client terminal 106 (step 612).

Next, or at some time thereafter, the employment candidate may log into a third-party social media site (step 614). The candidate may then update his profile on the third-party social media site with relevant job information (step 616). In various embodiments, the social media activity may include interacting with a recruiter's social media-based recruiting campaign on the third party social media site 104. The third-party server may then store this information in the employment candidate's social media profile (step 618).

Next, or at some time thereafter, the update information may be transmitted to the SRM 3301 (step 620). The update may be generated in response to an automated or periodic request by the SRM 3301 for the candidate's current social media site information. The social media information is then stored by the SRM 3301, for example, in SRM database 3319 (step 622).

An exemplary update to the profile of the employment candidate as stored in the SRM Database may take the following form:

<?PHP
header(′Content-Type: text/plain′);
// store input data in a database
mysql_connect(″201.408.185.132″,$DBserver,$password); // access
database server
mysql_select(″Accounts_DB.SQL″); // select database to append
mysql_query(“UPDATE interestProfileTable
SET candidateID = ‘1231123′ , activity_date = ′5/13/2014’,
activity_type = ′social_media_post’, socialMediaSite=’Twitter’,
contentType=’address change’, keyword content=’I just moved to my
new home in Dallas”, standardized_type=’current address’,
standardized_location = ‘Dallas, TX”;
mysql_close(″Accounts_DB.SQL″); // close connection to database
?>

The social media information is then parsed for job-related information (step 624). In various embodiments, such parsing may involve keyword matching between the social media information and a stored library of job-related terms. However, experience has shown that simple keyword matching can lead to many incorrect determinations with respect to an employment candidate's job history information. Accordingly then, the parsing may alternatively or additionally involve use of a knowledgebase data structure (such as Knowledgebase 3319m), which contains a variety of pre-established standard terms that correspond to particular jobs and job functions. The knowledgebase data structure may also correlate various non-standardized terms to one or more of the standardized terms, such that colloquial job-related information may be correlated to the standardized descriptions. Such standardized descriptions may be inserted into a candidate's job profile or a pre-formatted résumé generated on behalf of the employment candidate by the SRM 3301. In addition, since there are many job skills and requirements that are desirable for various types and kinds of employment positions to varying degrees, the knowledgebase data structure includes a prioritized ranking of various job skills and requirements against each stored job position or type. For example, “experience with JAVA SCRIPT” may be a desirable skill for job types such a website developer and an Information Technology Manager. However, it may be a more important skill for the former than the latter. Accordingly, the knowledgebase datastructure may assign a higher rank to the job skill “experience with JAVASCRIPT for the stored job title of “website developer” than for the stored job tide of “Information Technology Manager.” This feature in particular enables employment candidates to be more precisely matched to stored job postings and employment campaigns than prior systems, which have historically used simple keyword matching functions.

Continuing with the process, at step 626, it is determined whether there are any more updates to the employment candidate's job history information based on social media or other inputs or activities from the employment candidate. If so, the process returns to step 620 above. Otherwise, the process continues to step 628 where the SRM 3301 generates a notification of an update to the employment candidate's job profile. The notification is sent to the client terminal 106 for display to the employment candidate (step 630). Responsive thereto, the employment candidate may generate a message acknowledging the accuracy of the update or requesting a correction to the updated information (Step 632), which is then transmitted or sent to the SRM 3301, after which this instance of the process ends with respect to the employment candidate.

Turning to FIG. 7, the employment candidate and recruiting campaign matching process continues, in the case where the user is a recruiter to step 702, where the recruiter's account screen is presented on a display device of the client terminal 106. The recruiter supplies an input to generate a new campaign (Step 704), and responsive thereto, the SRM 3301 receives the input and retrieves a campaign options template for completion by the recruiter (step 708). The recruiting campaign options may be retrieved, for example, from the campaign database 3319f of the SRM database 3319.

The campaign options are then displayed to the recruiter as, for example, an editable web form (step 710). The recruiter may provide manual entries to an input/output device of the client terminal 106 to edit or enter any of the variety of available campaign options (step 712). The client terminal 106 then prepares and sends the selected options to the SRM 3301 (step 714), which receives and stores the campaign options, for example in the Campaign Database 3319f (step 716).

Next, at step 718, the SRM 3301 identifies any employment candidate profiles (as may be stored in Active Accounts database 3319a or Actionable Accounts database 3319b) that match the campaign options selected by the recruiter above.

The SRM 3301 then requests any updated social media information for matched employment candidate profiles from their related third-party social media sites 104 (step 720). Responsive thereto, the third-party social media sites 104 may assemble the candidates' social media information (step 722) and transmit it to the SRM via a data communications network (step 724).

Next, at step 726, the SRM 3301 may update the employment candidate's SRM account data with any job-related information obtained from the third-party social media information/sites.

The profiles of the matching candidates, with the updated social media information have job-related data, are then displayed to the recruiter in conjunction with the relevant employment recruiting campaign (step 728), after which this instance of the process ends with respect to the recruiter.

FIG. 8 shows a logic flow diagram illustrating embodiments of a first automated recruitment campaign process for the SRM, as may be used to establish a recruiting campaign in accordance with the foregoing disclosures. The process commences at step 602, after which a recruiter may enter, as an example of recruiting campaign options described previously above, a job title or a skill (step 804a). Alternatively, or in addition thereto, the recruiter may select an open job posting that exists on the SRM system (step 804b) and/or upload established job postings from an Applicant Tracking System, a VMS system or other type of well-known online job board (step 804c).

Next, the SRM system shows the best matched established job titles and skills based on the recruiter's entry (step 806a) or shows a list of matched existing job postings (step 806b). The recruiter may then select specific job tides and skills from the established list (step 808a) or select a single job from which to source candidates (step 808b).

The SRM system responsively combines terms from the job with selected user terms (step 810). One example of the programming instructions that may be used to accomplish this are as follows:

function getJobResultList(urlRequest, jobid) {

urlRequest = encodeURIComponent(urlRequest); // get matched

skills matching a job title from all jobs

xmlhttp = new XMLHttpRequest( );
xmlhttp.onreadystatechange = function( ) {

if (xmlhttp.readyState == 4 && xmlhttp.status == 200) {

var jobsResults = JSON.parse(xmlhttp.responseText);
// loop through all the variations in the jobs response

list

// identify each skill sorted by relevance score, add to

page,

// along with a checkbox next to each

}

urlRequest = encodeURIComponent(urlRequest + “&q=” + jobid); //

get list of skills from this job

xmlhttp = new XMLHttpRequest( );
xmlhttp.onreadystatechange = function( ) {

if (xmlhttp.readyState == 4 && xmlhttp.status == 200) {

var jobsResults = JSON.parse(xmlhttp.responseText);
// loop through all the variations in the jobs response

list

// identify each skill that is already present on the

page. If present, check the box next to

// that skill.

}

The SRM system then searches for and returns a list of matched employment candidates meeting those criteria (step 812). The recruiter then selects, via the client terminal 106, the matched candidates to contact by e-mail, messaging or phone (step 814), after which this first automated process ends.

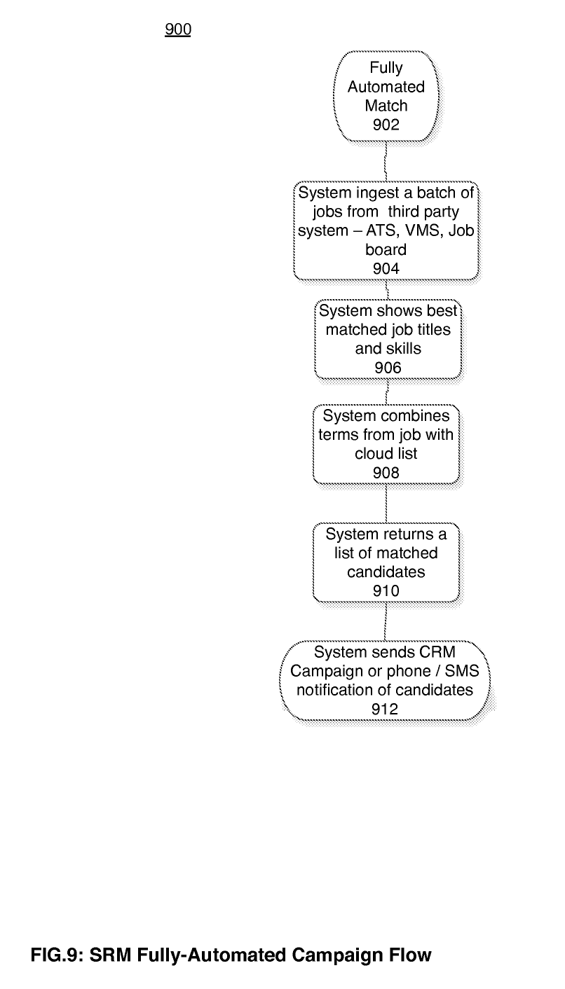

FIG. 9 shows a logic flow diagram illustrating embodiments of a second automated recruitment campaign process for the SRM, which commences at step 902. In this process, the SRM automatically creates a campaign for a recruiter by retrieving one or more job postings from an ATS, VMS or other job posting site (step 904). The SRM system then determines the best matched job titles and skills for a recruiter's desired campaign (step 906). The SRM system then combines terms from the job listings with one or more established, standardized job skills and titles, as may be stored in the knowledgebase data structure 3319m, or the like (step 908). In addition, the job skills and requirements may be ranked according to each job type within the knowledgebase, as previously described. In addition, or alternatively thereto, the skills for each job title may be assigned a ranking by a recruiter providing the job listing, rather than using the default rankings established by the SRM. Functionalities are provided to allow the recruiter to change job skill rankings by job type as desired. After this listing has been established, the SRM system returns a list of all matched employment candidates, which may be stored in Active Accounts database 3319a or Actionable Accounts database 3319b of the SRM Controller 3301 (step 910). Finally, at step 912, the SRM system sends pre-determined communications established by a recruiter for the job at a time that may also be established by a recruiter when selecting communications options as described previously above. This instance of the automated process then ends.

FIG. 10 shows a logic flow diagram illustrating embodiments of a third automated recruitment campaign process for the SRM, in which a previously unregistered employment candidate may search for jobs from employment recruiters via the campaigns that the recruiters have established on the SRM by any of the foregoing manners. At step 1004, an employment candidate may visit the SRM 33011 via client terminal 106. The candidate may then perform a search for a job for which the candidate feels qualified (step 1006). The system then presents job listings that are appropriate to the candidate's search (step 1008). The user then may select one or more of the returned results (step 1010). The SRM 3301 may track the job title, skills, location and company of the job listing selected by the candidate and append the candidate's profile with the relevant information concerning those jobs (step 1012). This may be done without any action from the employment candidate themselves to make such an appending. The results of the dynamically generated profile for the employment candidate may be stored in Actionable Accounts database 3319b, which is reserved for employment candidates that have not yet registered with the SRM system.

The user may then choose to apply to the job (step 1014). The SRM, upon detecting an application to a job on the SRM site, will first ask the unregistered candidate for the candidate's primary e-mail address(es) (step 1016). The e-mail address(es) are added to the candidate's SRM profile (Step 1018). The inputted e-mail address(es) may be the sole attribute necessary to enroll the candidate with the SRM system. Using the e-mail address(es), the SRM system may add information to the candidate's SRM profile by searching third-party social media or job posting sites based on the e-mail address, identifying the relevant third-party social media profiles based thereon, and parsing job-related information from those profiles in the manners previously described. The parsed job information is then added to the candidate's SRM profile, which may be stored in Actionable Accounts database 3319b. Upon activation of a candidate's profile in this manner, the candidate's profile may be removed from the Actionable Accounts database 3319b and stored in the Active Accounts database 3319a of the SRM Controller 3301.

Next, at step 1020, the candidate receives a job application form to complete. Here, the user may enter all job-related information as may commonly be found in a résumé into appropriate pre-established fields, which is then stored and updated by the SRM. This information may then be used, in conjunction with any parsed social media information, to generate a pre-formatted résumé according to the previously described processes, an example of which is shown in FIGS. 24 and 25. The user completes the application form at step 1022 and the candidate's application and résumé is stored by the SRM system (step 1024).

Next, or at some time before or thereafter, a recruiter may log into the SRM system (step 1026). The recruiter may establish a candidate query in conjunction with a recruiting campaign (step 1028). At step 1030, the SRM system then searches for matching employment candidates (for example, from the profile information stored in databases 3319a and 3319b). The SRM system may then append and interlace any matching candidate information with parsed information from third-party social media web sites, as previously described. The matching candidates are then displayed to the recruiter (step 1032). Finally, at step 1034, the profiles of the matching candidates, with the updated social media information having job-related data, are then contacted in accordance with the rules established by the employment recruiting campaign or as otherwise established by the recruiter, after which this instance of the process ends.

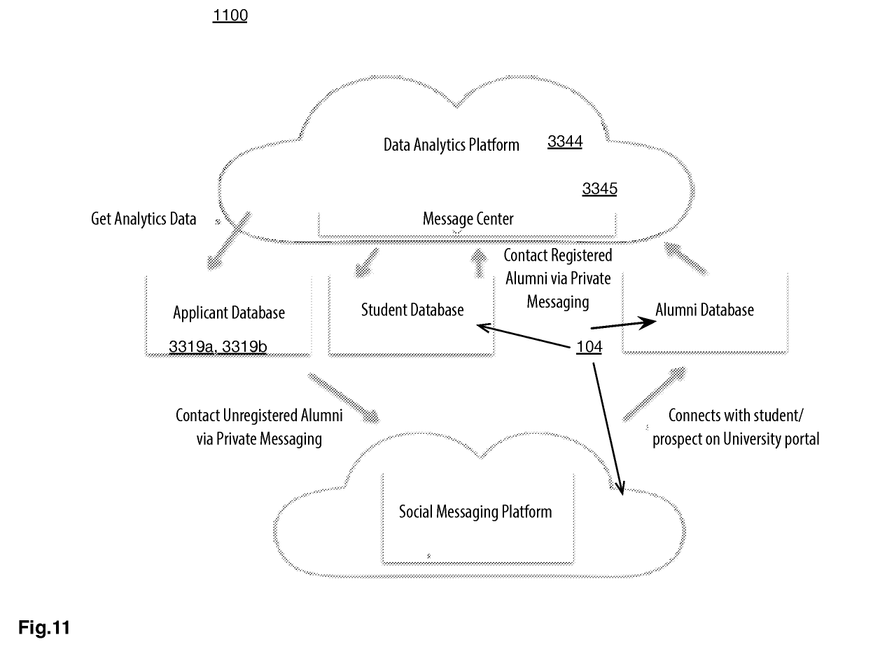

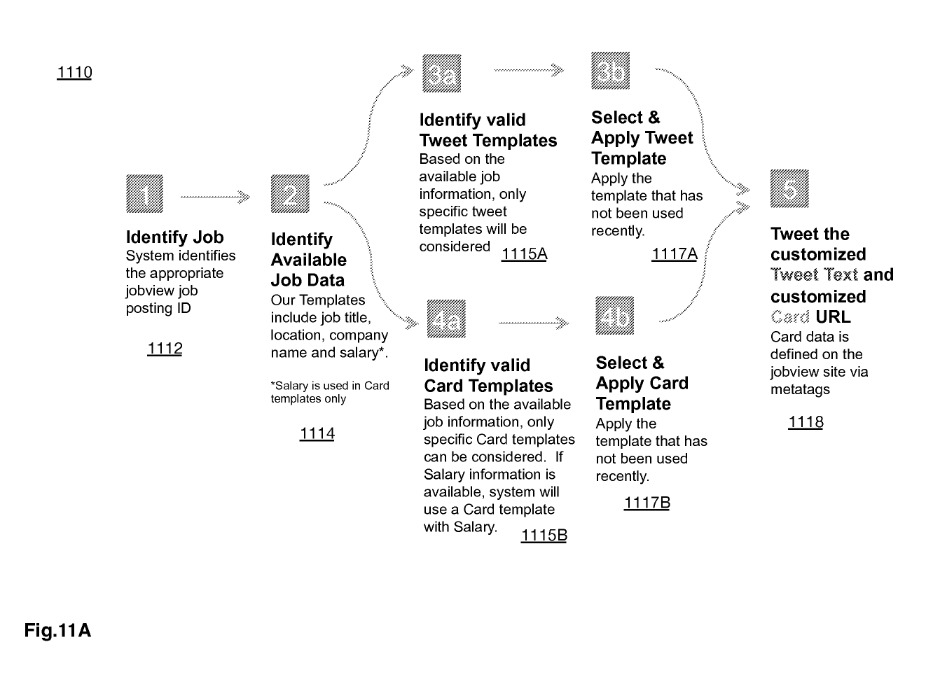

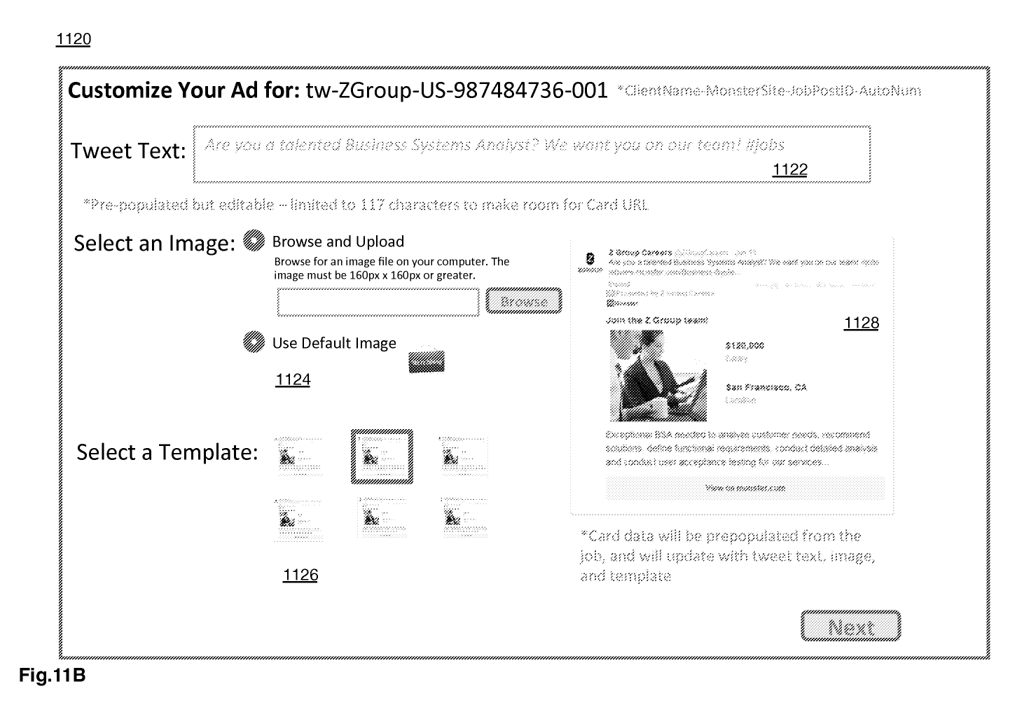

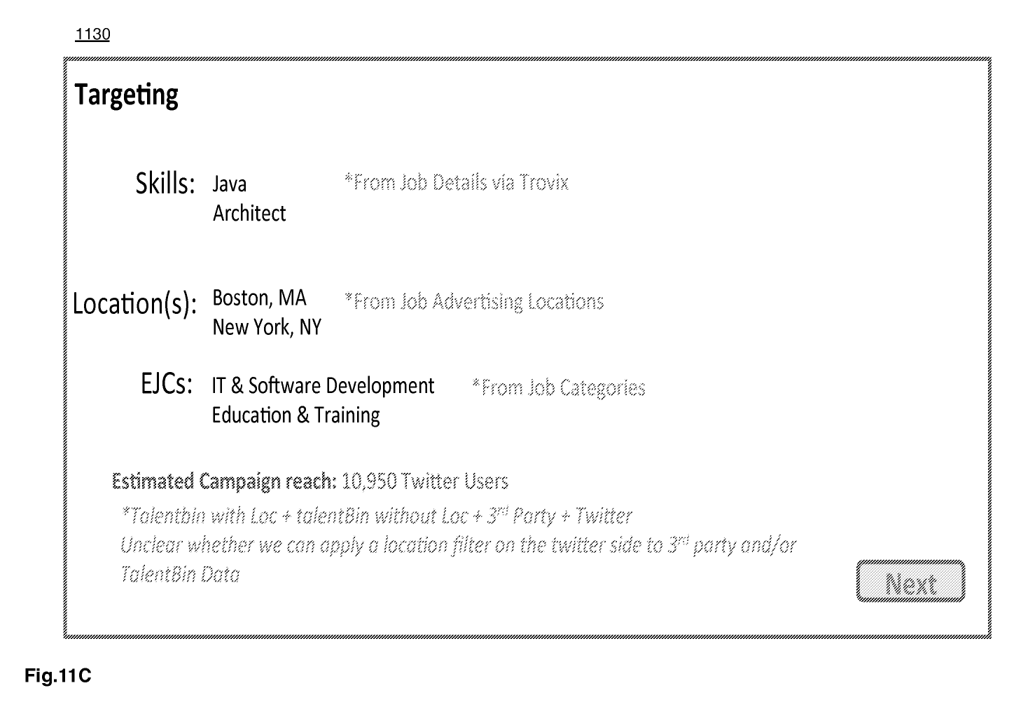

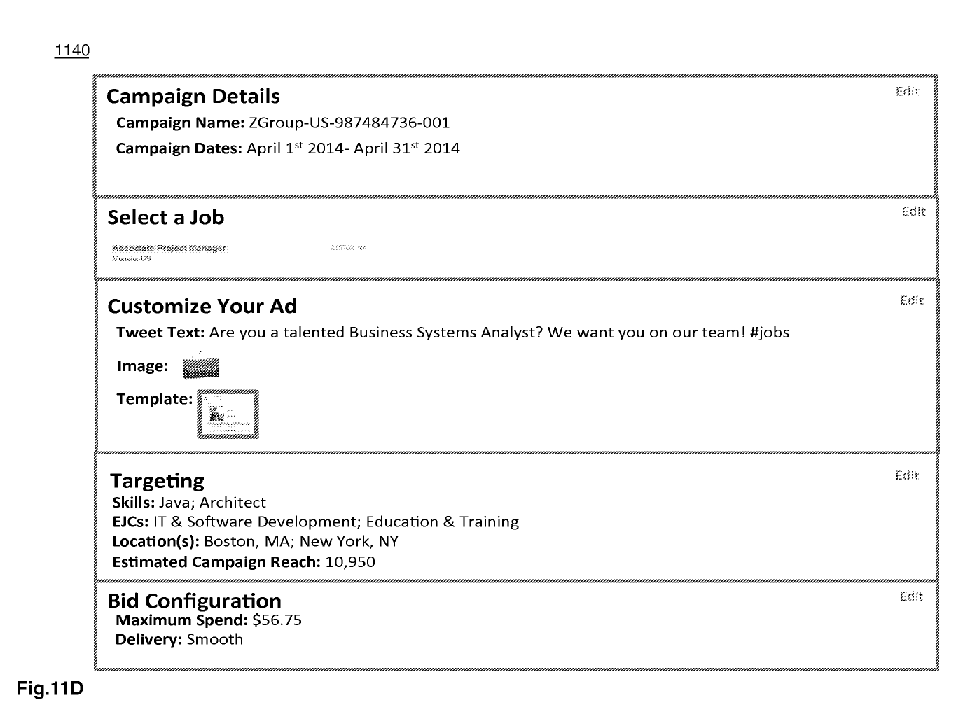

FIG. 11 shows a conceptualization of the means by which the SRM gathers employment information from a plurality of social media network sites. The Data Analytics Platform Component 3344 of the SRM 3301 gets analytics data from interactions between candidates having SRM profile information as stores in Active Accounts Database 3319a and Actionable Accounts Database 3319b. This analytics data may be used by a supervisor of the SRM, recruiters, and the like to evaluate the effectiveness of various recruiting campaigns established on the SRM. For example, the Data Analytics Platform component 3344 may monitor the number of campaign views and responses received from employment candidates, as well as the timing and efficiency of finding and employing an employment candidate, and compares them to established norms in order to determine whether, for example, an employment campaign or strategy as implemented on the SRM is effective and in what areas it may be improved.

In various embodiments, the SRM system may incentivize recruiters to establish successful employment recruiting campaigns, or to urge lower-performing recruiters to improve their performance. For example, in the case where a recruiter's marketing campaigns have resulted in response rates from candidates that is higher than historical performances for like campaigns or job types, the SRM system may enable the recruiter to exceed a predetermined limit on number of campaigns or campaign-related communications, without additional charge or to receive preferred pricing on additional SRM features, such as launching social media-based campaigns. Conversely, the SRM system may impose restrictions on the number of campaigns or communications allowed, or increase the fees to the recruiter for using the SRM system or its various features. Other means of incentivizing and rewarding recruiters without limitation will be readily apparent to one of ordinary skill in the art.

The Data Analytics Platform component 3344 may also monitor and retrieve information from student database 3319k and alumni database 3319l, which may be stored by the SRM 3301 and updated from third-party student and alumni databases, as may be maintained by universities, colleges, high schools and the like. The information in these databases are largely relevant to an employment candidates job history and useful for completing sections of the pre-formatted résumés described herein with respect to the prior education of the candidate. The alumni databases may also for determining candidate attributes, such as current location and outside interests of the employment candidates. When changes are entered into third-party student and alumni databases, which correspond to changes in SRM profile data of an employment candidate, the Data Analytics Platform Component 3344 retrieves and parses such changes and adds them to a candidates profile information, as may be stored in Student database 3319k or Alumni database 3319l of the SRM Controller 3301. Likewise, the Data Analytics Platform Component 3344 monitors the various third-party social media sites 104 for changes to candidates' social media profiles stored therein, particularly when such profile data contains job-relevant information. In addition thereto, the SRM may monitor publicly available social media sites 104 for information entered by users other than the candidate, but which also reference the employment candidate. For example, an employment candidate may be mentioned on a social media of another user in a publicly-available post. Such post may be examined for job-related terms or job-relevant information and such parsed information may be added to the SRM profile of the employment candidate.

Furthermore, a Messaging Component 3345 monitors the messages and responses transmitted via the SRM between candidates and recruiters. The Messaging Component 3345 may store messaging and response data in the Communication database 3319g of the SRM 3301.

FIG. 11A shows an exemplary social media-based recruiting campaign message generation process 1110 performed by the SRM system. The process 1110 allows a recruiter to create an employment campaign on the SRM System, and then established a pre-formatted social media message that may be generated by the SRM system from campaign information entered by the recruiter, and then distribute such message on a third-party social media platform, such as FACEBOOK, TWITTER or the like. The social media account may be established automatically by the SRM on the social media platform. The SRM may charge a fee to the recruiter for such functionality. Alternatively, the SRM may be granted permissions and provided electronic credentials for placing the social media message on the social media platform from the recruiter's established social media account.

The process 1110 commences at step 1112, when the SRM system receives an identification of an employment campaign for which a social media message is to be generated. Data on the job title, skills, location, salary and other requirements are identified by the SRM (step 1114) from the information on the campaign as entered by the recruiter.

At step 1115A, the SRM system determines appropriate message text to be inserted in the social media message based on the job data supplied by the recruiter. The knowledgebase data structure 3319m may store a plurality of standardized text descriptors for job titles required skills, and the like that may be retrieved and entered as a standardized text template for the social media message.

At step 1115B, the SRM system chooses a predefined graphics template with text and image layout areas that are to be populated with recruiting campaign information as entered by the recruiter. The predefined graphics template serves as the format of the social media message that is to be distributed on the social media website.

At steps 1117A and 1117B, the text template and graphics template selected by the SRM based on job type are combined and populated with the job data entered by the recruiter. Finally at step 1118, the text and graphic templates are combined to form the social media message, which is then transmitted to the third-party social media site for targeted or public distribution.

FIG. 11B shows an exemplary screen display of a social media message generating screen 1120 as may be presented to a recruiter for generating a social media message as part of a recruiting campaign according to the process 1110 above. The template 1120 may include a text entry field 1122, an image selection field 1124, a template selection field 1126, and a social media message preview window 1128.

The text entry field 1122 is provided by the SRM system to receive entry of a description of an available job, including job title, skills, location and salary. Additional text may likewise be entered. Alternatively, or in addition thereto, the text may be selected from standard knowledgebase terms and entered by the SRM system. Such automatic entry may be the default entry into the text entry field 1122 for a particular recruiting campaign, and may be further approved or altered by a recruiter.

The image selection field 1124 allows a recruiter to select one or more graphic files or other types of stored image for placement into the social media message generated according to process 1110. The template selection field 1126 allows a recruiter to select a predetermined format for the social media message as provided by the SRM system.

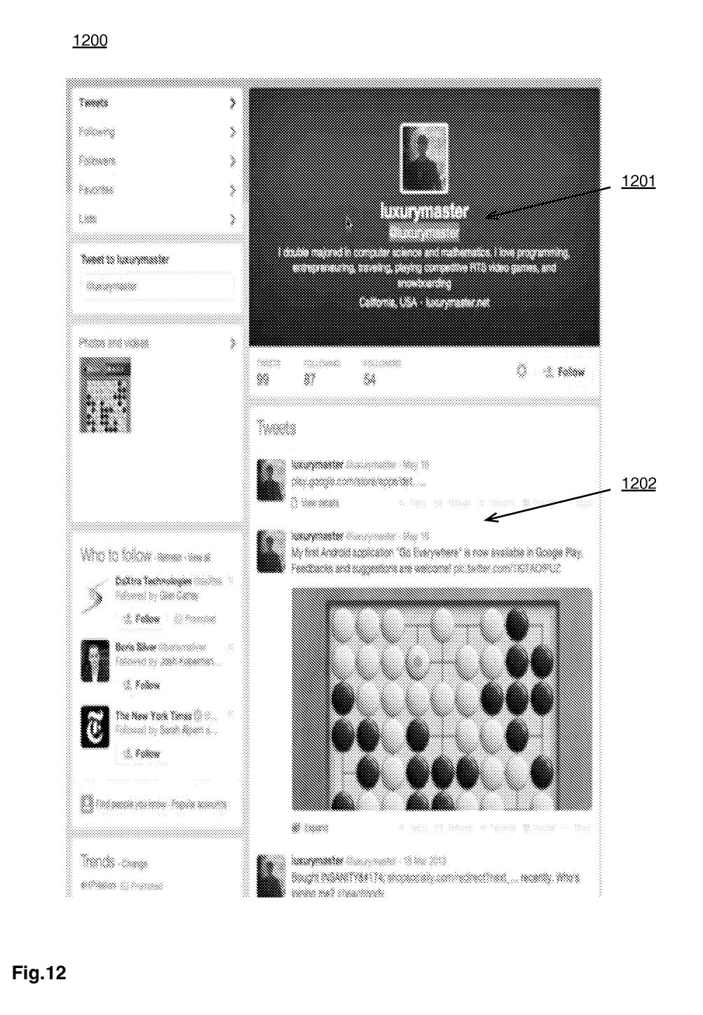

The social media message preview window 1128 allows a recruiter to view a preview of the social media message generated according to the entered text, image selections, template selections s previously described. The message as displayed in the preview window 1128 corresponds to how the message will appear on a posting on a third-party social media website, such as is shown in FIG. 12.

FIG. 11C shows an exemplary screen display of a text summary screen 1130, as may be shown to the recruiter during the process 1110. The text summary screen 1130 shows the job skills, job location and other job descriptors that may be entered into the text field above, or otherwise established by the SRM, for the employment recruiting campaign.

FIG. 11D shows an exemplary screen display of a social media message summary screen 1140, in which the recruiter may view and edit the following attributes of a recruiting campaign to be implemented on the social media site: campaign name, job title, message image, message template, required skills, job location and a maximum budget for the campaign (which may be address fees charged by the SRM system and/or the social media site). Other message preferences may be entered here and stored by the SRM system for example in Campaign database 3310f.

FIG. 12 shows an exemplary screen display of a social media account of an employment candidate, from which information is obtained by the SRM. Alternatively, or in addition thereto, posts from recruiter's campaigns as posted to third-party social media sites may be viewed herein. As is typical of such sites, there is a social media profile area 1201, where background information on a candidate may be displayed. Such information may include, for example, the name, location, and contact information (such as e-mail address or social media handle), as well as any outside interests, professional detail and other personal information that the candidate wishes to display. Such web sites also typically include a messaging area 1202, where a candidate may message other user of the social media site, or receive messages therefrom. Oftentimes, such messaging information (as well as other information provided by the social media site) includes information on an employee's job or outside interests and activities. This type of data is searched and parsed by, for example, a Monitoring Component 3342 of the SRM 3301, as described in this disclosure, to obtain useful job related information to be added to the candidate's SRM profiles.

FIGS. 13-29 show exemplary screen shots of screens presented to a recruiter on a display device of the client terminal 106 in order to establish and utilize an employment recruiting campaign using the SRM.

FIG. 13 shows an exemplary welcome screen 1300 that may be presented to recruiter having an account with the SRM system. The welcome screen 1300 may include a menu bar 1302, from which a variety of available functions are accessible by the recruiter. Such functions include accessing current job listings, accessing SRM profiles of employment candidates, campaign creation and management functions and the like. The welcome screen 1300 may further include a posting window 1304, from which the recruiter may create new job listings or recruiting campaign. The welcome screen 1300 may also include a search window 1306, from which a recruiter may generate a search for employment candidates using various attributes. The welcome screen 1300 may also include a Candidate Folders window 1308, from which a recruiter may access saved profiles of employment candidates of interest.

FIG. 14 shows an exemplary New Campaign Screen 1400, from which a recruiter may create a new employment recruiting campaign. The New Campaign Screen 1400 may include a plurality of fields, in which a recruiter can input text to generate a new recruiting campaign. These fields may include a Campaign Name field 1402, by which the recruiter may name the campaign; a Search field 1404, in which the recruiter may enter qualifications and criteria that employment candidate profiles must match; a Location field 1406, for designating a geographic location of the open employment position(s) for the campaign; a Skills field 1408 for listing the skills required for the open employment position(s), a Résumé Updated field 1410 for indicating how recent the résumés of employment candidates must be; and a Message Creation window 1412, for generating an initial electronic message to candidate's that match the campaign's requirements.

FIG. 15 shows an exemplary Campaign Summary Screen 1500, in which a recruiter may view a summary of the campaign and its results. Accordingly, the screen 1500 may include a Search Results window 1502, in which candidate matching the campaign's criteria may be displayed with summary information from their profiles and résumés. The screen 1500 may also include a Message Content Window 1504, in which messages that have been or are scheduled to be sent to a candidate are displayed to, and available for editing by, the recruiter.

FIG. 15A shows an exemplary Campaign Search screen 1510 by which a recruiter may search for employment candidates having certain attributes using the SRM system. The SRM system allows the recruiter to generate many search criteria groups for locating desired employment candidates. The SRM system further allows the recruiter to combine multiple searches together into a single campaign. Each separate search may involve different selections and rank weightings of skills, requirements and job titles within the campaign. Candidate profiles that are returned by the SRM for one, many or all established searches within a recruiter's campaign may then be stored by the recruiter and/or selected by the recruiter for review and contact. The SRM system my display statistics of the various searches separately and/or together. The number of such combinable searches may be limited by the SRM system based on fees paid by the recruiter, and may be enhanced or diminished in accordance with the performance of the recruiter's campaign against historical benchmarks.

FIG. 15B shows an exemplary Search Results screen 1520, from which a recruiter can view information on employment candidates who have been matched to the recruiter's campaign by the SRM system. The recruiter's may be allowed to view an employment profile of the candidate, or a résumé of the employment candidate in response to a search or recruiting campaign. The SRM system may further allow the recruiter to enter a candidate search into search window 1522. The search results may be presented in search results window 1524.

FIG. 15C shows an exemplary job search screen 1530 that may be presented to a recruiter in order for the recruiter to select a standardized job tide with which to conduct a candidate search on the SRM system. As described herein, the recruiter may use the standardized job tide to search for qualified employment candidates as part of a recruiting campaign or other job search. Accordingly, a recruiter may first be presented with a search bar 1532 into which the recruiter may enter a description of a job, such as providing one or more job-relevant search terms.

FIG. 15D shows an exemplary entry of a job-related search term into the search bar 1532.

FIG. 15E shows the screen 1530 with job search results window 1534 that is presented to a recruiter in response to the entry of the job search in the search bar 1532. The window 1534 may present a list of job tides in the SRM system that correspond to employment candidates having the associated job tide. Each listed job tide in the window 1534 may be selected by a recruiter using an input device of the client terminal 106 or the like.

The standardized job tide search results window 1536 of the screen 1530 lists all standardized job tides and skills stored in the SRM system that may be relevant to the search term entered into the search bar 1532 by the recruiter. The results may be presented in relevance order, alphabetical order or some other manner that at may be selectable by the recruiter. The results may also be listed with the number of available employment candidates stored by the SRM system having the listed job tide or skill.

FIG. 15F shows the screen 1530 after a recruiter has selected a search result in window 1534. Responsive to the selection, the SRM system will display to the recruiter those related job titles and skills listed in window 1536 that correspond to that particular search result. Accordingly, a first set of titles and skills may be highlighted in the window 1536 when a recruiter selects a first job search result in window 1534. A second set of titles and skills may be highlighted in the window 1536 when a recruiter selects a different job search result in window 1534. In this manner, the recruiter may determine employment profiles of interest more quickly than having to scan through individual profile details for a given set of job search results.

FIG. 15G shows the screen 1530 after a recruiter has selected related job titles and skills listed in the window 1536 in order to conduct or refine candidate search results for the recruiting campaign. In this instance, instead of search individual candidate listings by job title from the window 1534, the recruiter can alternately select the related job skills and titles from window 1536 that are being sought in relation to an open employment position that is the subject of the recruiting campaign. When a recruiter makes a selection in this manner, a further results window 1538 may be presented to the recruiter, in which the SRM system displays individual candidate profile listings corresponding to employment candidates having profiles with standardized job titles and skills that match those selected by the recruiter in window 1536. The individual candidate listings are each selectable by the recruiter using, for example, an input device of a client terminal 106.

FIG. 15H shows the screen 1530 after a recruiter has selected an individual candidate listing from the window 1538. Upon a selection of a profile listing, the SRM system presents a candidate profile window 1540 to the recruiter. The candidate profile window may list candidate profile and/or résumé information (as described herein) for a candidate that is selected by the recruiter from the window 1538. The recruiter may then use the profile and/or résumé information to determine which candidates to contact initially as part of an employment recruiting campaign.

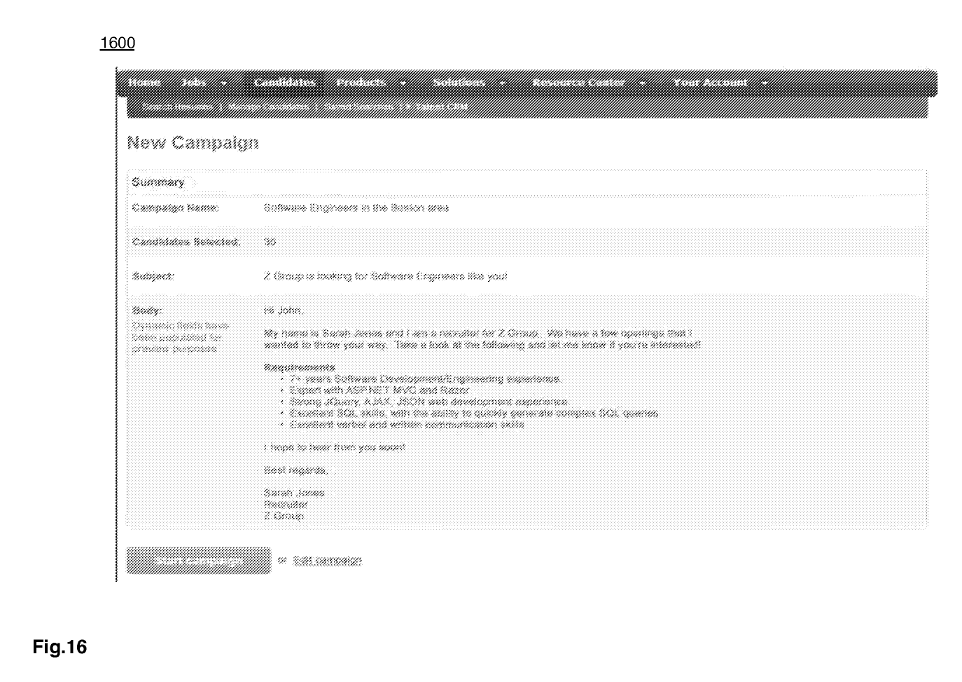

FIG. 16 shows an exemplary Campaign Message Summary window 1600, in which a recruiter may view a summary of an initial campaign-generated message that may be sent to one or a group of matching employment candidates.

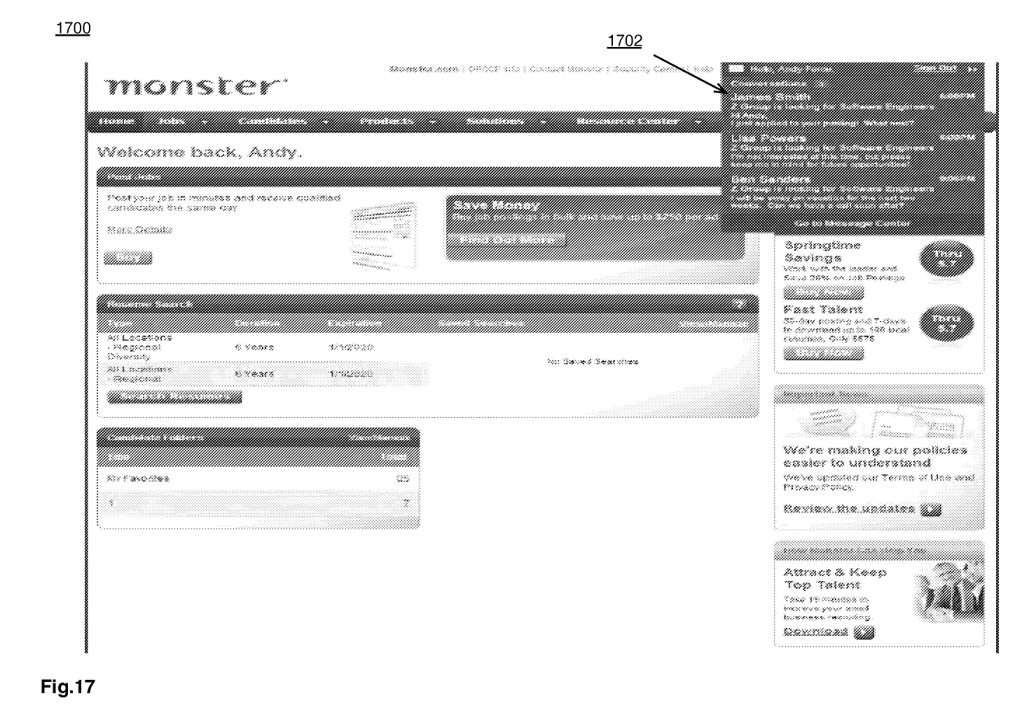

FIG. 17 shows an exemplary Response Notification screen 1700 having a Response Notification window 1702, from which a recruiter may be notified of responses from employment candidates that have been received in response to a recruiter's campaign messages or jobs listings.

FIG. 18 shows an exemplary Message Center screen 1800 having a Message Summary window 1802, from which a recruiter can view more details about responses from employment candidates that have been received in response to a recruiter's campaign messages. The SRM allows the recruiter to manage the responses from this screen, such as marking responses as read or unread, opening the response to view them in full, or deleting a response.

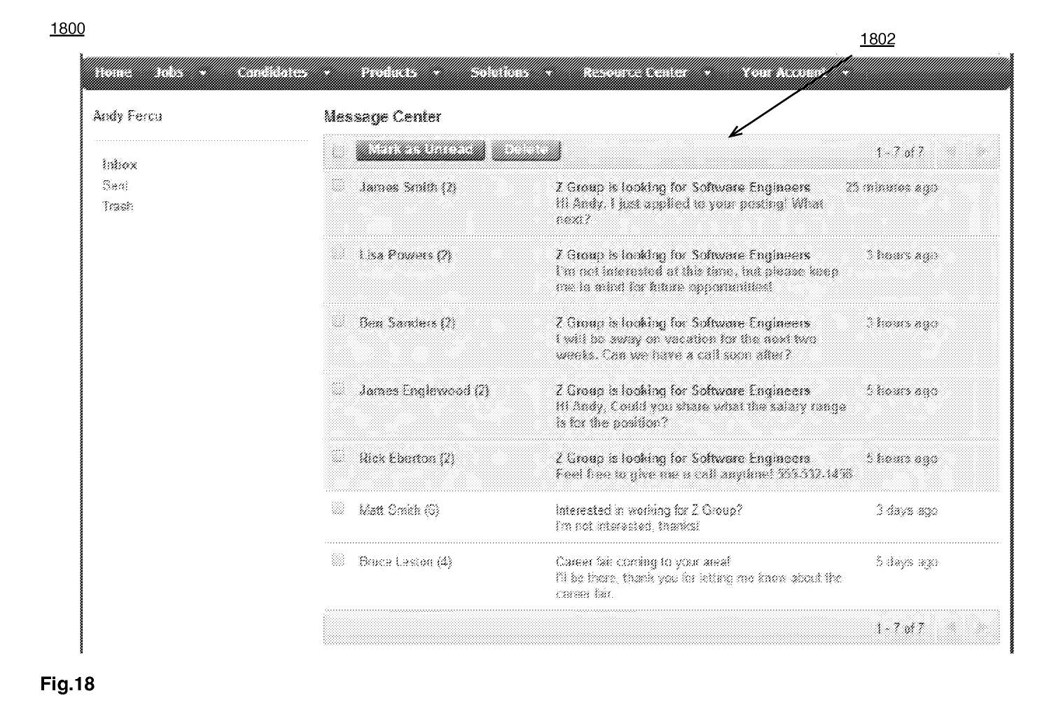

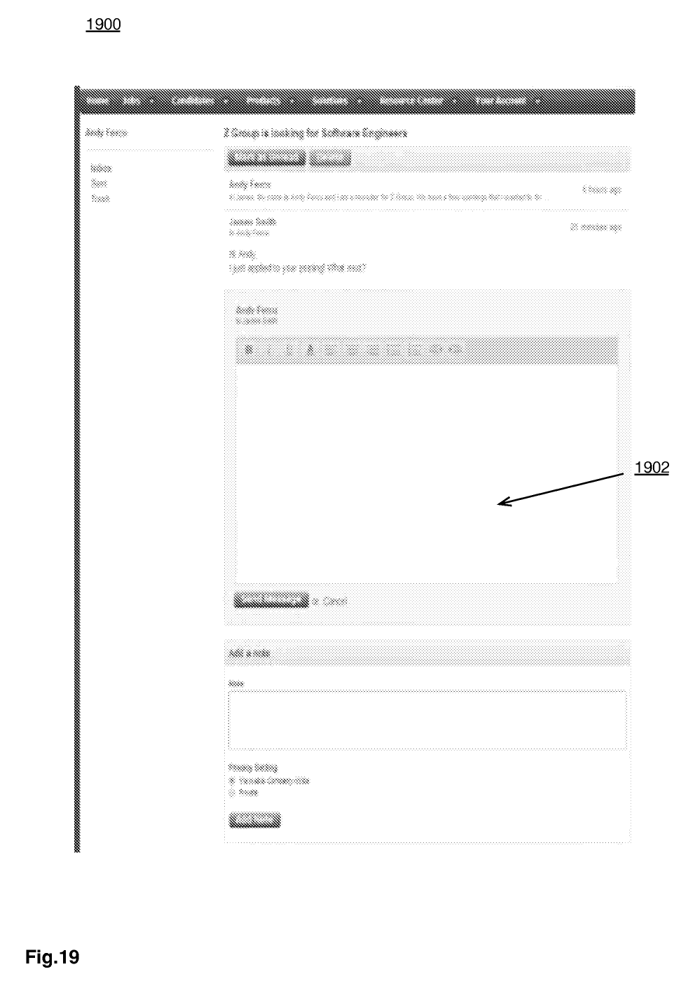

FIG. 19 shows an exemplary Message Scheduling screen 1900, from which a recruiter may generate a message to one or more employment candidates and schedule a time that the SRM system is to send the generated message. Accordingly, the screen 1900 may include a Messaging window 1902 for generating an electronic message to be sent to the candidate. The message may be sent immediately upon selection of a send function. Alternatively, the recruiter may select a specific date and/or time that the message may be dispatched to the employment candidate.

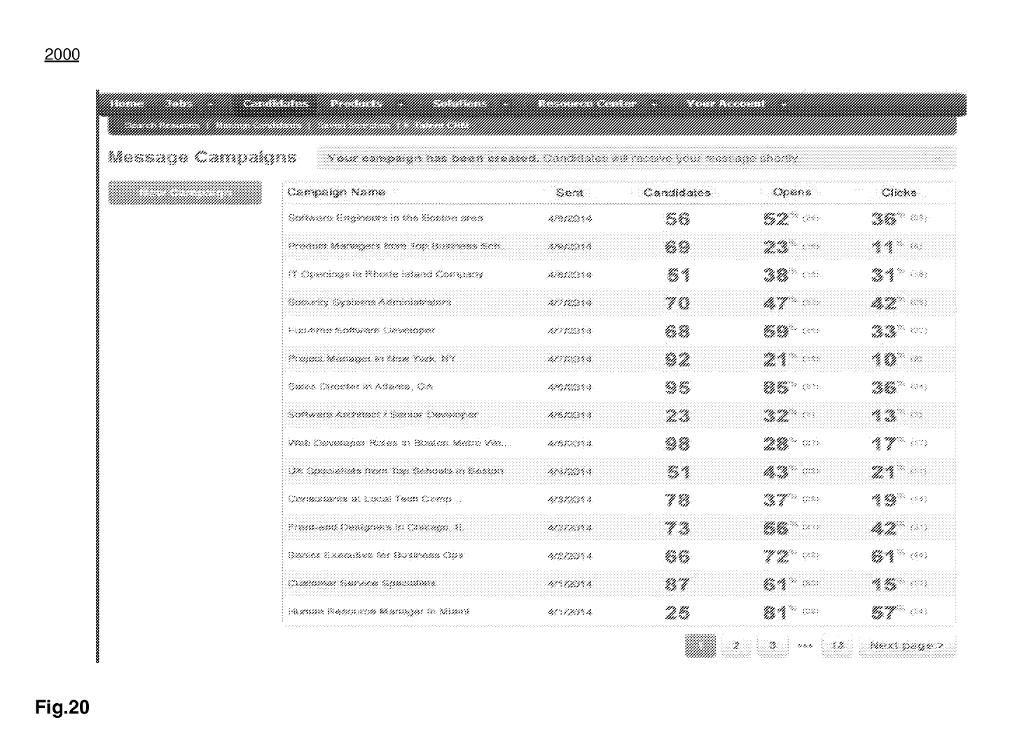

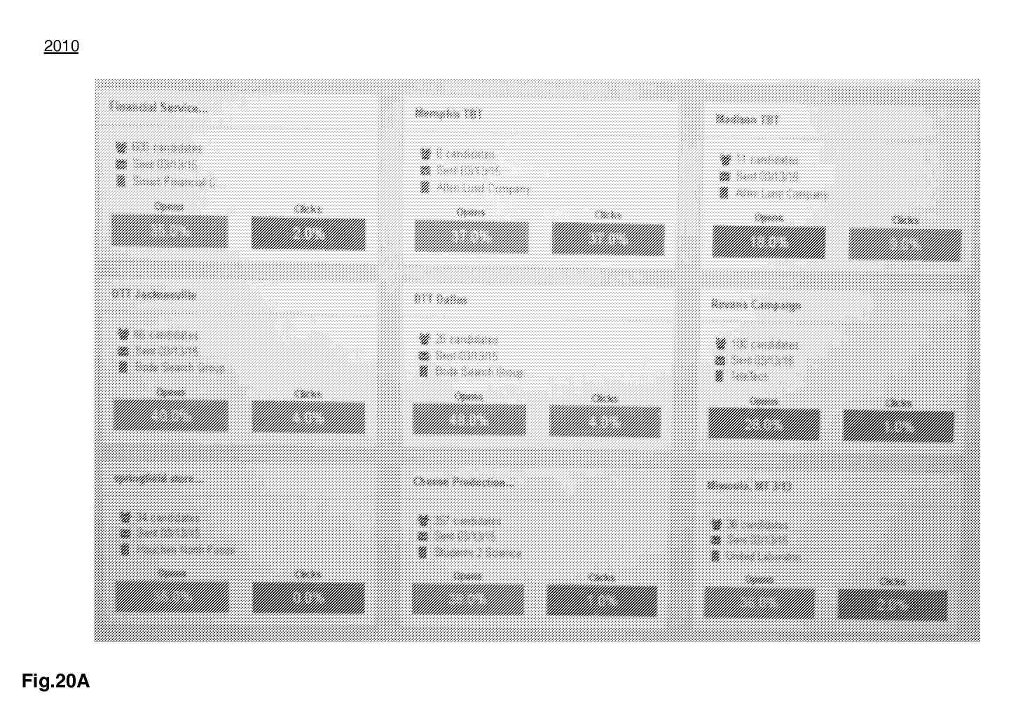

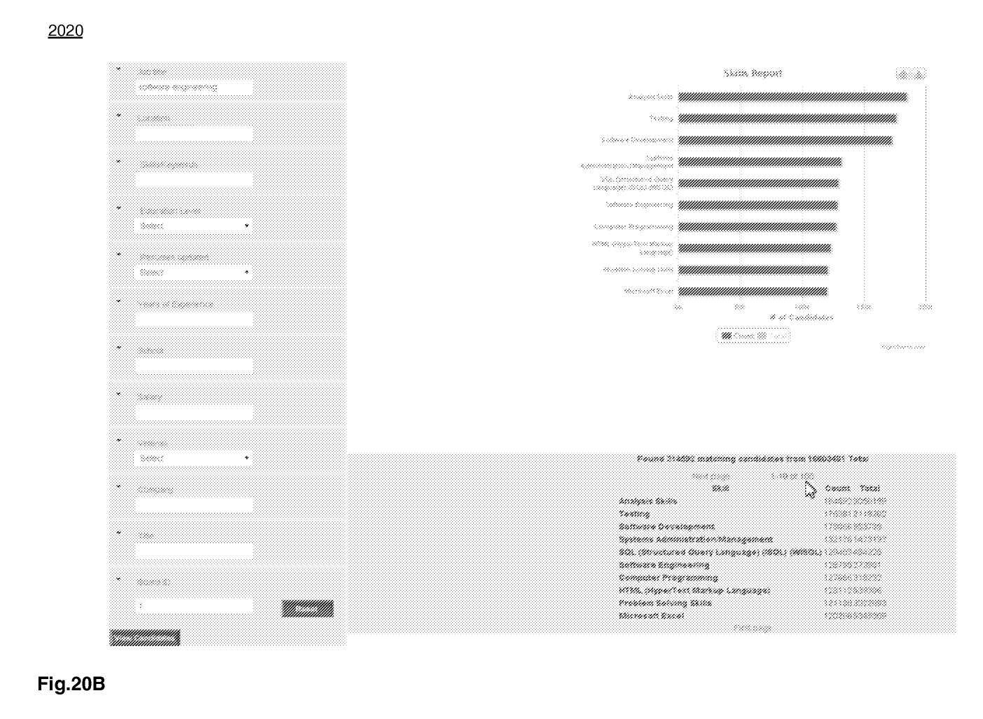

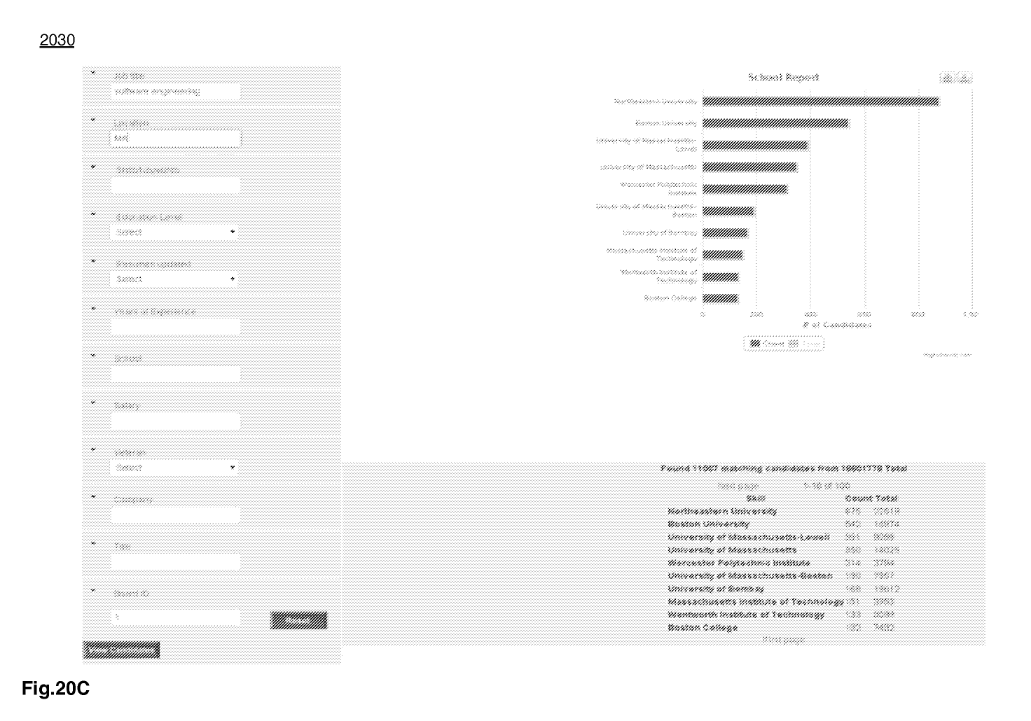

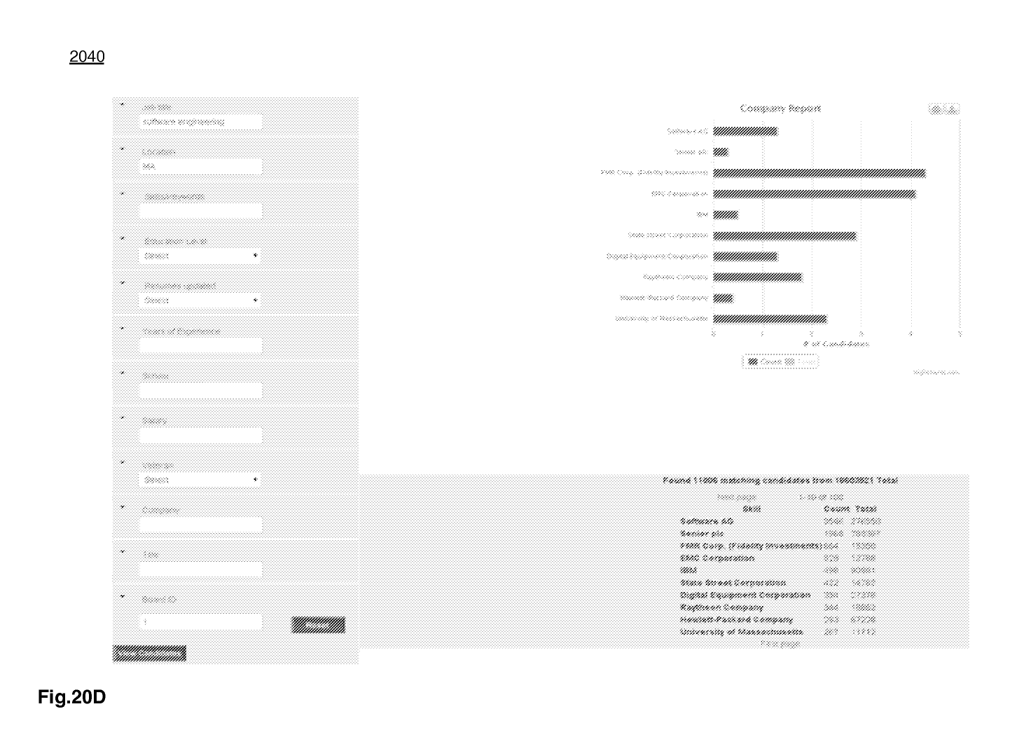

FIG. 20 shows an exemplary Campaign Summary screen 2000, from which a recruiter may review statistics on various campaigns. The screen 2000 may show campaign names, the date each campaign was created, the number of candidates contacted during the campaign, the number of campaign messages that were opened by candidates that were messaged, and the number of responses received from contacted candidates. This campaign summary data may be compiled by the Monitoring component 3342 of the SRM Controller 3301, as described later below. This campaign summary data may be used by the Analytics component 3344 to determine the effectiveness of the recruiting campaigns as described herein.

FIG. 20A shows an exemplary first campaign statistics screen display 2010, in which a recruiter using the SRM for campaigns, or an administrator of the SRM system, my view summary statistics of an employment search request, a plurality of search requests, an employment campaign, or plurality of recruiting campaigns implemented via the SRM system. As shown therein, there may be a plurality of windows presented, wherein each window may show a campaign name and summary statistics for the campaign, such as: a percentage of contacted employment candidates that responded to each campaign, a number of views of a campaign message, a number of messages sent to and received from candidates, date of commencement of the campaign and other relevant summary campaign information s described herein.

FIG. 20B shows an exemplary screen display of a first campaign analysis screen 2020 that may be generated by the Analytics component 3344 of the SRM system, and presented to a recruiter. In this instance, the recruiter may view statistics on the number of candidates having each skill required for a job listing provided as part of a recruiter's recruiting campaign.

FIG. 20C shows an exemplary screen display of a second campaign analysis screen 2030 that may be generated by the Analytics component 3344 of the SRM system, and presented to a recruiter. In this instance, the recruiter may view statistics on the number of candidates who match the requirements of a recruiting campaign and have attended particular educational institutions.

FIG. 20D shows an exemplary screen display of a third campaign analysis screen 2040 that may be generated by the Analytics component 3344 of the SRM system, and presented to a recruiter. In this instance, the recruiter may view statistics on the number of candidates who match the requirements of a recruiting campaign and have previously been employed by particular companies. It is readily contemplated that all types of statistics regarding the functions described herein may be collected for a recruiting campaign, as well as for all recruiting campaigns implemented by the SRM system. These statistics may be gathered by the Analytics Component 3344 and stored in Statistics database 3319j of the SRM system.

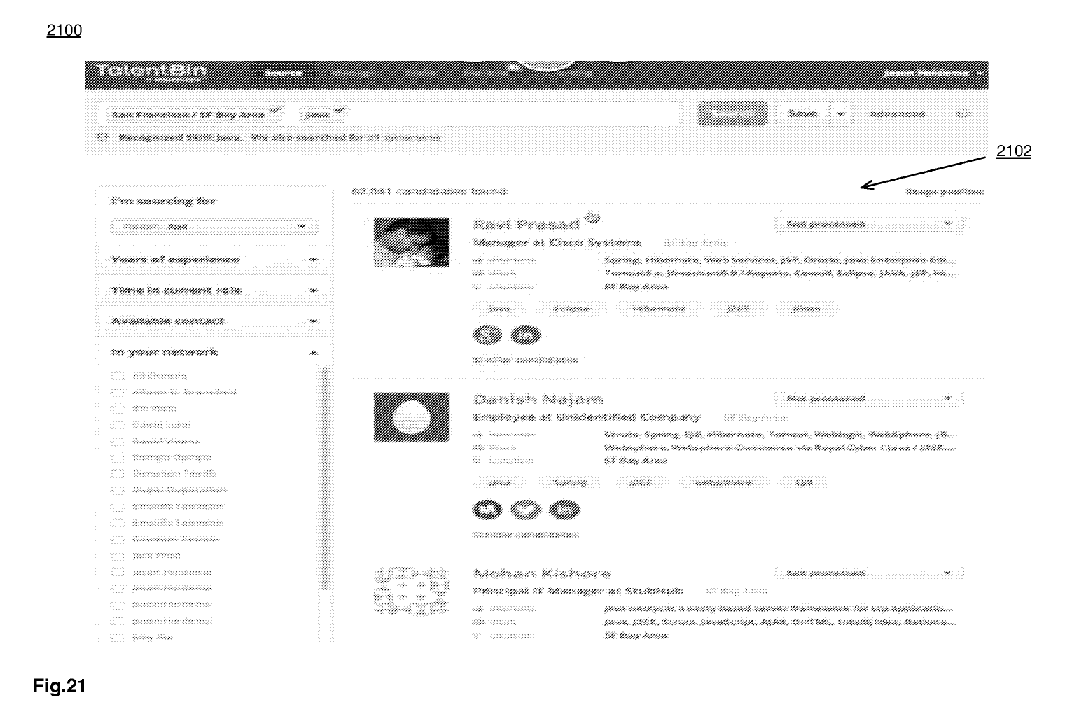

FIG. 21 shows another exemplary welcome screen that may be presented to a recruiter wishing to generate a recruiting campaign. However, in this example, the recruiter may be initiating the SRM processes described above from the recruiter's own client-branded site. Accordingly, a client-branded Welcome screen 2100 may include a Search window 2102, from which a recruiter may generate a search for employment candidates, and view the results of such search.

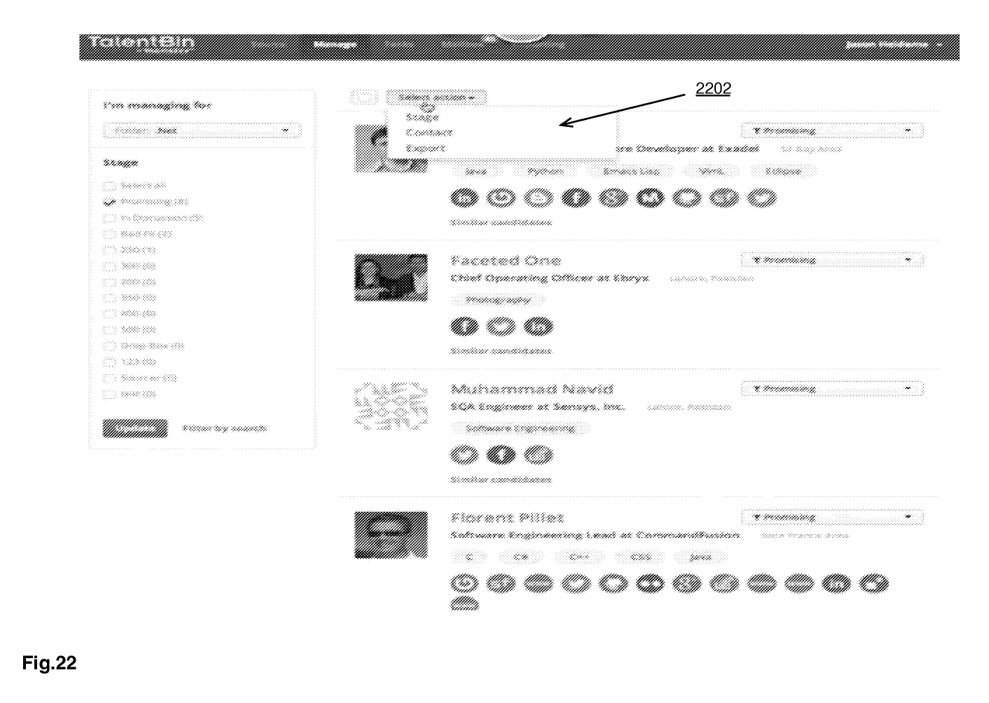

FIG. 22 shows a Contact functions menu 2202 of the screen 2100, from which a recruiter may select various options for contacting selected employment candidates.

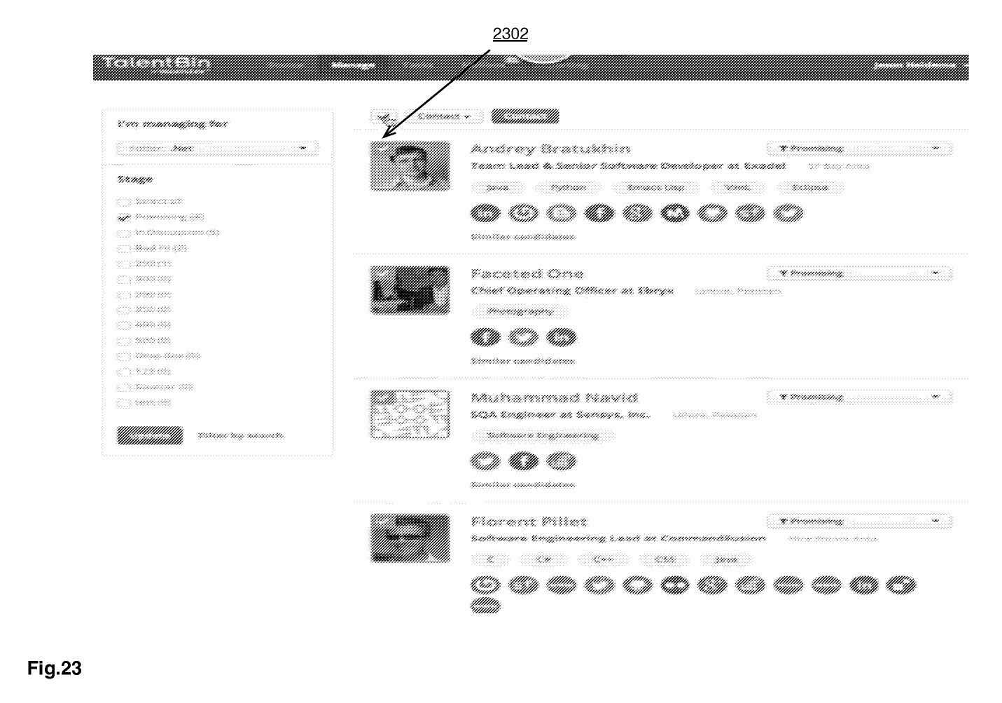

FIG. 23 shows selection functions 2302 of the screen 2100, from which a recruiter may select various employment candidates to be contacted.

FIGS. 24-25 show a client-branded Résumé Viewing screen 2400, from which a recruiter may view résumés of candidates as stored by the SRM. In various embodiments, the résumé may be pre-formatted résumés generated by the SRM 3301 for each employment candidate as described in the foregoing. Accordingly, the screen 2400 may show a pre-formatted résumé of a candidate 2402 and a task status window 2404. The résumé 2402 may include pre-determined text as generated by the SRM 3301 for the job type and may further include information obtained from the employment candidate or by data from social media profiles of the candidate hosted on third-party social media sites. The résumé 2402 may include the name and contact information for a candidate, links to the candidate's social media profiles, a job history of the candidate including positions held, job responsibilities, job skills and dates of employment. The task status window 2404 shows the status of contacts between the recruiter and the employment candidate, and may include fields for entering notes about the candidate as determined by the recruiter.

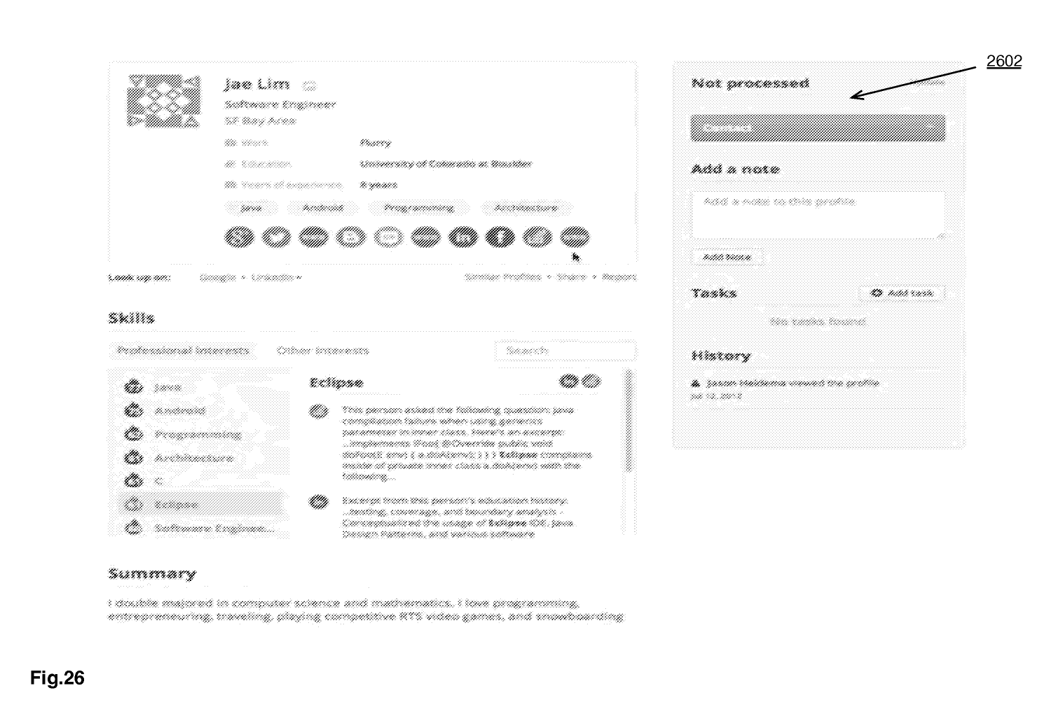

FIG. 26 shows a contact indication 2602 in the task status window 2404, which may be presented when a recruiter chooses to initiate a contact with an employment candidate.

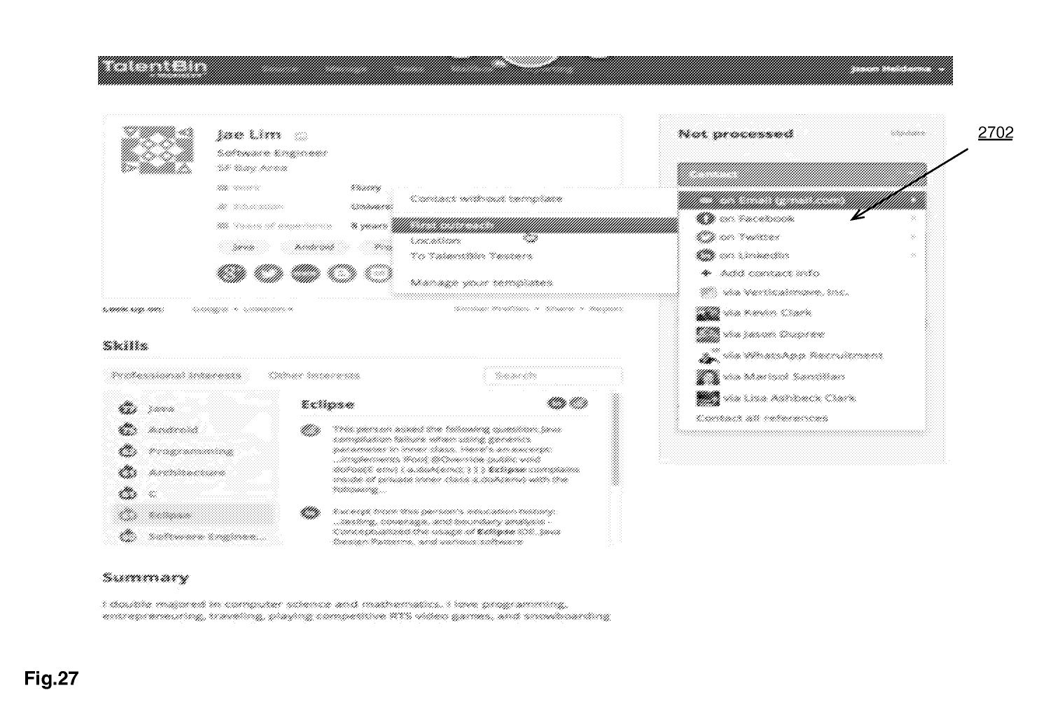

FIG. 27 shows a message type selector 2702, which may be used by the recruiter do determine the type of electronic message to be sent (i.e., e-mail message, text message, social media message).

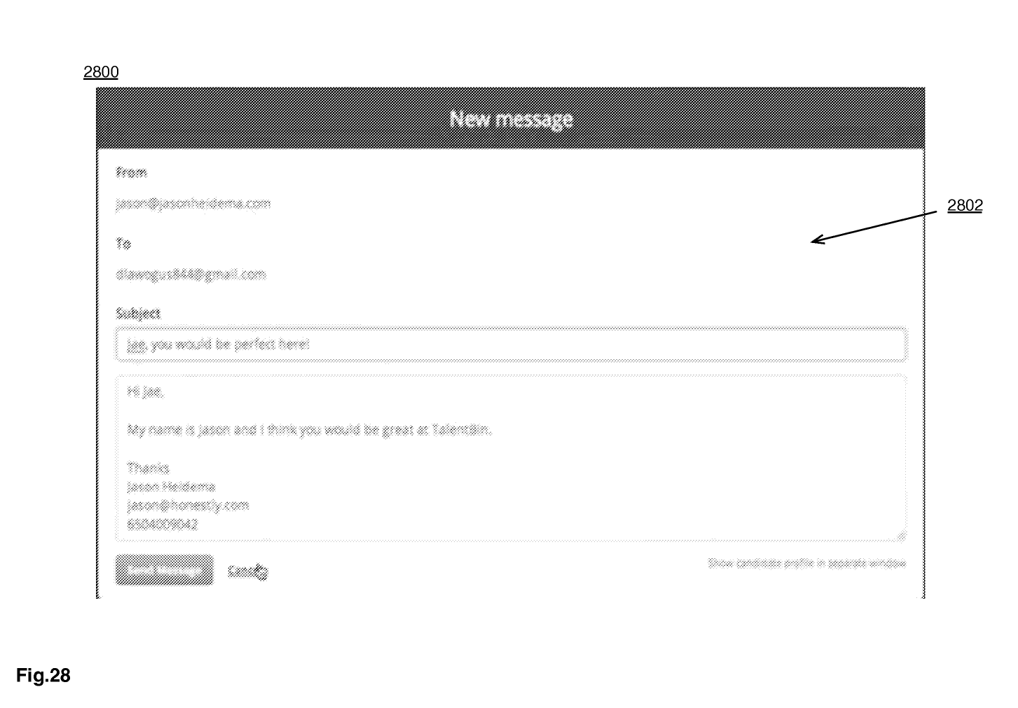

FIG. 28 shows a New Message screen 2800 that may be presented to a recruiter when the recruiter chooses to make a contact or other outreach to an employment candidate. The screen 2800 may include a Message window 2802, in which a pre-formatted or new message may be generated by the recruiter and sent to the employment candidate.

FIG. 29 shows an exemplary Task Generation screen 2900 that may be presented to the recruiter. The recruiter may enter a name and description of a task to be completed with respect to a recruiting campaign or contact with an employment candidate, and means for selecting a date and time that such task is due for completion. This information may be stored by an SRM system (for example, in Activities database 3319i of the SRM 3301). The Messaging Component 3345 of the SRM 3301 may transmit a message to the recruiter regarding the task at the established task due date.

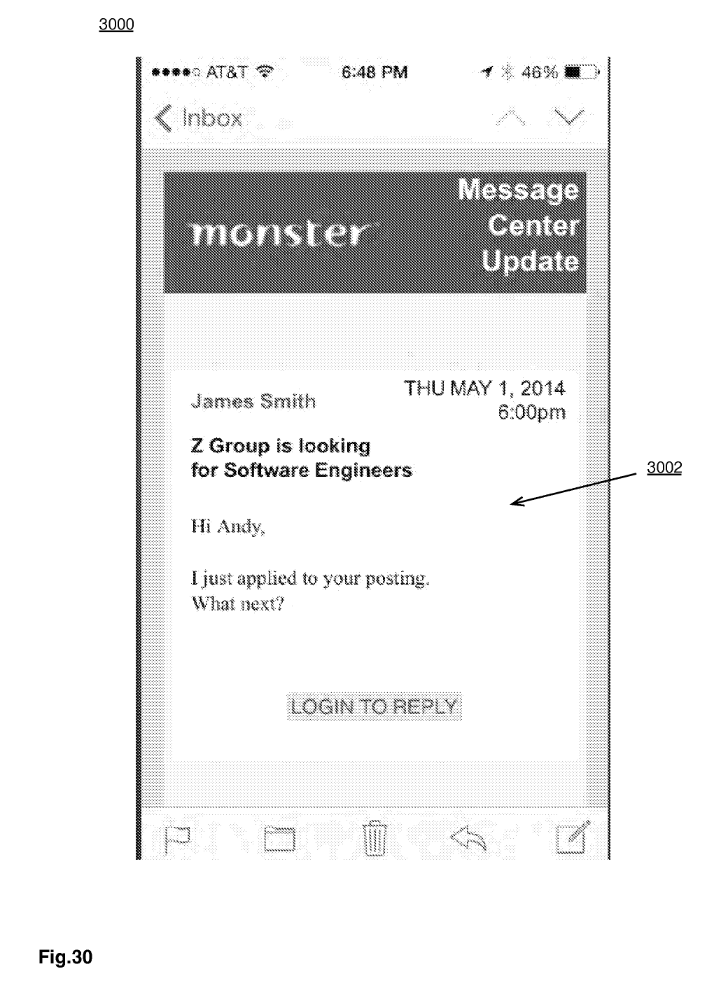

FIGS. 30-32 show exemplary screen shots of screens presented to an employment candidate using the SRM. In various embodiments, screen shots 30-32 represent screen displays that are optimized for mobile personal computing or communication devices, such as smartphones or tablets of the type commonly manufactured by APPLE, MICROSOFT, DELL, HEWLETT-PACKARD and others.

FIG. 30 shows an exemplary Candidate Welcome screen 3000 that may be presented to the candidate accessing the SRM system from a client terminal 106, such as a personal computing device or a smartphone, having a display device. The screen 3000 may include a Message window 3002 for presenting a summary of any messages sent to the employment candidate via the SRM system. These may include messages from a recruiter as apart of a recruiting campaign. There may also be options presented to the candidate for responding to any received messages.

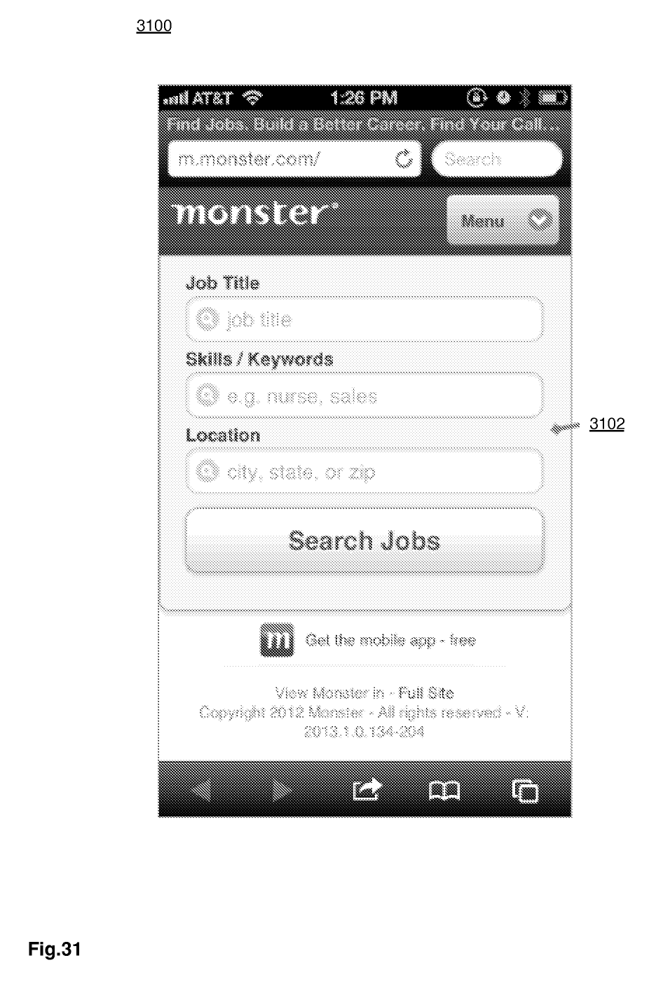

FIG. 31 shows an exemplary Job Listing Search screen 3100 that may be presented to a candidate's device by the SRM system. The screen 3100 may include a Search window 3102 having a number of fields for generating a search of job listings hosted by the SRM system. The fields may include, for example, a Job Title field, a Skills field and a geographic location field. The candidate may enter a desired job title, his/her employment skills and geographic location, in order to filter the stored job listings to identify suitable job listings that the candidate may choose to pursue.

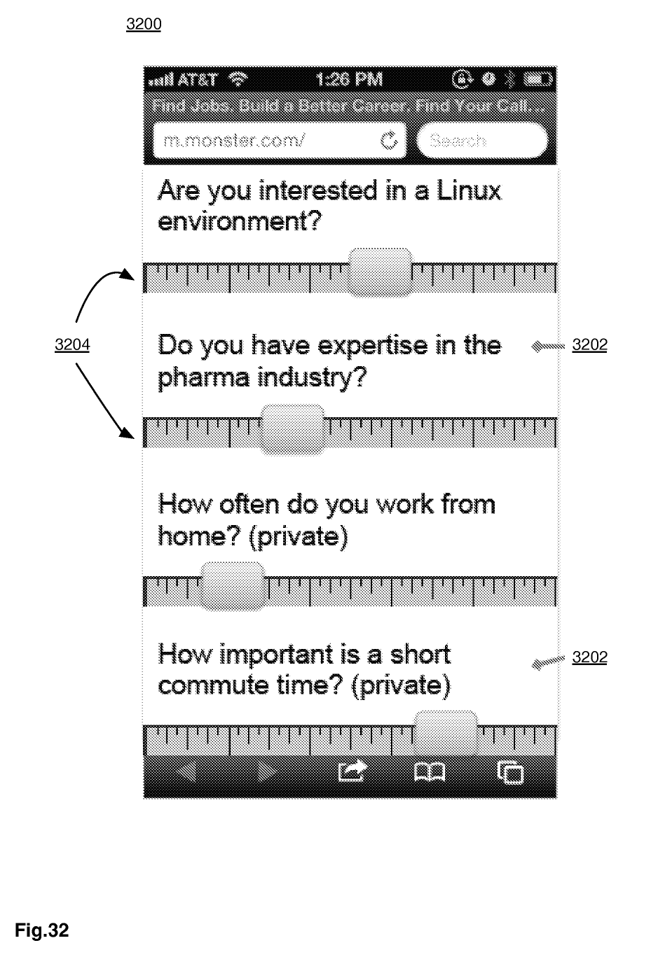

FIG. 32 shows an exemplary job history entry window 3200, in which candidates may enter information about their job histories. In various embodiments, the screen 3200 may include a number of job history-related questions 3202. The screen 3200 may further include a slide bar under each question for the client to choose an appropriate answer. Other forms of entry to posed questions, such as a text entry field, may likewise be used.

### SRM

The SRM facilitates a number of tasks to manage online interactions, particularly between employment candidates and employment recruiters. For example, in one embodiment, the SRM may allow automated prompts to be sent to job seekers under certain conditions. For example, after a seeker shows interest in a job, automated emails may be scheduled to be sent at specified intervals and/or triggers. Before the SRM a recruiter could only manually send these reminder/outreach emails.

In various embodiments, the SRM will host an account and profile as established by entries from an employment candidate. The SRM may also use the candidate's profile information to access other social media profiles of the candidate hosted on third-party social media sites and parse this information for job-related data, which in turn, may then be added to the candidate's SRM profile and/or a pre-formatted résumé that may be generated for the candidate by the SRM system. In another embodiment, the SRM will gather information from social networks about a candidate and build an actionable inactive account profile for the candidate, without the candidate's participation. The actionable inactive account may later be activated by the candidate when he/she chooses to enroll with the SRM system. Upon such enrollment, which, in various embodiments, may be accomplished by simply entering an e-mail address of the candidate, the candidate maybe presented with a pre-populated candidate profile having information obtained from the candidate's social media accounts. The job-related information obtained for the candidate may be obtained from additional sources. For example, a candidate currently not participating with the SRM may have his friends take his photo and post his information on their accounts. That information may be parsed by the SRM. For example, the non-subscribed candidate may have photos, videos, comments and other information shared by his friends, and that information, in turn, may be used to populate an actionable inactive account for the candidate. Later, when the unsubscribed candidate gets links from the SRM to view or participate in campaigns, the candidate may be prompted to join the SRM. When the previously unsubscribed candidate joins the SRM, the candidate may engage in a one-click account creation, since the previously inactivate account was prepopulated and stored in actionable form. The SRM site may be a web site that facilitates matching employment candidates with employment recruiters having job positions to be filled in the manners described herein.

### SRM Controller

FIG. 33 shows a block diagram illustrating embodiments of a SRM controller 3301, which may serve to aggregate, process, store, search, serve, identify, instruct, generate, match, and/or facilitate interactions with a computer through customer and social management technologies, and/or other related data.

Typically, clients, who may be people and/or other systems, may engage information technology systems (e.g., computers) to facilitate information processing. In turn, computers employ processors to process information; such processors 3303 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 3329 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the SRM controller 3301 may be connected to and/or communicate with entities such as, but not limited to: one or more users from user input devices 3311; peripheral devices 3312; an optional cryptographic processor device 3328; and/or a communications network 3313.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The SRM controller 3301 may be based on computer systems that may comprise, but are not limited to, components such as: a computer systemization 3302 connected to memory 3329.

### Computer Systemization

A computer systemization 3302 may comprise a clock 3330, a central processing unit (“CPU(s)” and/or “processor(s)” (these terms are used interchangeable throughout the disclosure unless noted to the contrary) 3303, a memory 3329 (e.g., a read only memory (ROM) 3306, a random access memory (RAM) 3305, etc.), and/or an interface bus 3307, and most frequently, although not necessarily, are all interconnected and/or communicating through a system bus 3304 on one or more (mother)board(s) 3302 having conductive and/or otherwise transportive circuit pathways through which instructions (e.g., binary encoded signals) may travel to effectuate communications, operations, storage, etc. The computer systemization may be connected to a power source 3386; e.g., optionally the power source may be internal. Optionally, a cryptographic processor 3326 and/or transceivers (e.g., ICs) 3374 may be connected to the system bus. In another embodiment, the cryptographic processor and/or transceivers may be connected as either internal and/or external peripheral devices 3312 via the interface bus I/O. In turn, the transceivers may be connected to antenna(s) 3375, thereby effectuating wireless transmission and reception of various communication and/or sensor protocols; for example the antenna(s) may connect to various transceiver chipsets (depending on deployment needs), including: Broadcom BCM4329FKUBG transceiver chip (e.g., providing 802.11n, Bluetooth 2.1+EDR, FM, etc.); a Broadcom BCM4750IUB8 receiver chip (e.g., GPS); a Broadcom BCM4335 transceiver chip (e.g., providing 2G, 3G, and 4G long-term evolution (LTE) cellular communications; 802.11ac, Bluetooth 4.0 low energy (LE) (e.g., beacon features)); an Infineon Technologies X-Gold 618-PMB9800 transceiver chip (e.g., providing 2G/3G HSDPA/HSUPA communications); a MediaTek MT6620 transceiver chip (e.g., providing 802.11a/b/g/n, Bluetooth 4.0 LE, FM, global positioning system (GPS) (thereby allowing SRM controller to determine its location); a Texas Instruments WiLink WL1283 transceiver chip (e.g., providing 802.11n, Bluetooth 3.0, FM, GPS); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 3329 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the SRM controller and beyond through various interfaces. Should processing requirements dictate a greater amount speed and/or capacity, distributed processors (e.g., Distributed SRM), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the SRM may be achieved by implementing a microcontroller such as CAST's R8051XC2 microcontroller; Intel's MCS 51 (i.e., 8051 microcontroller); and/or the like. Also, to implement certain features of the SRM, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the SRM component collection (distributed or otherwise) and/or features may be implemented via the microprocessor and/or via embedded components; e.g., via ASIC, coprocessor, DSP, FPGA, and/or the like. Alternately, some implementations of the SRM may be implemented with embedded components that are configured and used to achieve a variety of features or signal processing.

Depending on the particular implementation, the embedded components may include software solutions, hardware solutions, and/or some combination of both hardware/software solutions. For example, SRM features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the SRM features. A hierarchy of programmable interconnects allow logic blocks to be interconnected as needed by the SRM system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the SRM may be developed on regular FPGAs and then migrated into a fixed version that more resembles ASIC implementations. Alternate or coordinating implementations may migrate SRM controller features to a final ASIC instead of or in addition to FPGAs. Depending on the implementation all of the aforementioned embedded components and microprocessors may be considered the “CPU” and/or “processor” for the SRM.

### Power Source

The power source 3386 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 3386 is connected to at least one of the interconnected subsequent components of the SRM thereby providing an electric current to all subsequent components. In one example, the power source 3386 is connected to the system bus component 3304. In an alternative embodiment, an outside power source 3386 is provided through a connection across the I/O 3308 interface. For example, a USB and/or IEEE 1394 connection carries both data and power across the connection and is therefore a suitable source of power.

### Interface Adapters

Interface bus(ses) 3307 may accept, connect, and/or communicate to a number of interface adapters, conventionally although not necessarily in the form of adapter cards, such as but not limited to: input output interfaces (I/O) 3308, storage interfaces 3309, network interfaces 3310, and/or the like. Optionally, cryptographic processor interfaces 3327 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 3309 may accept, communicate, and/or connect to a number of storage devices such as, but not limited to: storage devices 3314, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 3310 may accept, communicate, and/or connect to a communications network 3313. Through a communications network 3313, the SRM controller is accessible through remote clients 106 (e.g., computers with web browsers) by users 106a. Network interfaces may employ connection protocols such as, but not limited to: direct connect, Ethernet (thick, thin, twisted pair 10/100/1000/10000 Base T, and/or the like), Token Ring, wireless connection such as IEEE 802.11a-x, and/or the like. Should processing requirements dictate a greater amount speed and/or capacity, distributed network controllers (e.g., Distributed SRM), architectures may similarly be employed to pool, load balance, and/or otherwise decrease/increase the communicative bandwidth required by the SRM controller. A communications network may be any one and/or the combination of the following: a direct interconnection; the Internet; Interplanetary Internet (e.g., Coherent File Distribution Protocol (CFDP), Space Communications Protocol Specifications (SCPS), etc.); a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a cellular, WiFi, Wireless Application Protocol (WAP), I-mode, and/or the like); and/or the like. A network interface may be regarded as a specialized form of an input output interface. Further, multiple network interfaces 3310 may be used to engage with various communications network types 3313. For example, multiple network interfaces may be employed to allow for the communication over broadcast, multicast, and/or unicast networks.

Input Output interfaces (I/O) 3308 may accept, communicate, and/or connect to user input devices 3311, peripheral devices 3312, cryptographic processor devices 3328, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/ac/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 3311 often are a type of peripheral device 3312 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 3312 may be connected and/or communicate to I/O and/or other facilities of the like such as network interfaces, storage interfaces, directly to the interface bus, system bus, the CPU, and/or the like. Peripheral devices may be external, internal and/or part of the SRM controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 3328), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the SRM controller may be embodied as an embedded, dedicated, and/or monitor-less (i.e., headless) device, wherein access would be provided over a network interface connection.

Cryptographic units such as, but not limited to, microcontrollers, processors 3326, interfaces 3327, and/or devices 3328 may be attached, and/or communicate with the SRM controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory 3329. However, memory is a fungible technology and resource, thus, any number of memory embodiments may be employed in lieu of or in concert with one another. It is to be understood that the SRM controller and/or a computer systemization may employ various forms of memory 3329. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 3329 will include ROM 3306, RAM 3305, and a storage device 3314. A storage device 3314 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW) DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 3329 may contain a collection of program and/or database components and/or data such as, but not limited to: operating system component(s) 3315 (operating system); information server component(s) 3316 (information server); user interface component(s) 3317 (user interface); Web browser component(s) 3318 (Web browser); database(s) 3319; mail server component(s) 3321; mail client component(s) 3322; cryptographic server component(s) 3320 (cryptographic server); the SRM component(s) 3335; and/or the like (i.e., collectively a component collection). These components may be stored and accessed from the storage devices and/or from storage devices accessible through an interface bus. Although non-conventional program components such as those in the component collection, typically, are stored in a local storage device 3314, they may also be loaded and/or stored in memory such as: peripheral devices, RAM, remote storage facilities through a communications network, ROM, various forms of memory, and/or the like.

### Operating System

The operating system component 3315 is an executable program component facilitating the operation of the SRM controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the SRM controller to communicate with other entities through a communications network 3313. Various communication protocols may be used by the SRM controller as a subcarrier transport mechanism for interaction, such as, but not limited to: multicast, TCP/IP, UDP, unicast, and/or the like.

### Information Server

An information server component 3316 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the SRM controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the SRM database 3319, operating systems, other program components, user interfaces, Web browsers, and/or the like.

Access to the SRM database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the SRM. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the SRM as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 3317 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 3318 is a stored program component that is executed by a CPU. The Web browser may be a conventional hypertext viewing application such as Microsoft Internet Explorer or Netscape Navigator. Secure Web browsing may be supplied with 128-bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the SRM enabled nodes. The combined application may be nugatory on systems employing standard Web browsers.

### Mail Server

A mail server component 3321 is a stored program component that is executed by a CPU 3303. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the SRM.

Access to the SRM mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 3322 is a stored program component that is executed by a CPU 3303. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 3320 is a stored program component that is executed by a CPU 3303, cryptographic processor 3326, cryptographic processor interface 3327, cryptographic processor device 3328, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the SRM may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the SRM component to engage in secure transactions if so desired. The cryptographic component facilitates the secure accessing of resources on the SRM and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The SRM Database

The SRM database component 3319 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the SRM database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the SRM database is implemented as a data-structure, the use of the SRM database 3319 may be integrated into another component such as the SRM component 3335. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 3319 may include several tables 3319a-m. An active account table 3319a includes fields such as, but not limited to: an accountID, accountName, accountAddress, recruiterID, scheduleID, candidateID, candidateName, candidateAddress, candidateTelephone, candidateEmail, externalHandle, currentJobTitle, currentJobSkills, currentJobLocation, currentEmploymentDates, previousJobTitle, previousJobSkills, previousJobLocation, previousEmploymentDates, and/or the like. The user table may support and/or track multiple entity accounts on a SRM.

An InactiveActionableAccount table 3319b may include fields such as, but not limited to: inAccountID, inAccountName, inAccountEmail, inAccountAddress, candidateName, candidateAddress, candidateTelephone, candidateEmail, externalHandle, currentJobTitle, currentJobSkills, currentJobLocation, currentEmploymentDates, previousJobTitle, previousJobSkills, previousJobLocation, previousEmploymentDates, and/or the like.

An Outreach table 3319c may include fields such as, but not limited to: scheduleID, scheduleTime, scheduleTrigger, candidateID, recruiterID, messageType, messageSubjectline, messageContent, messageReceivedflag, messageOpenflag, messageResponseReceived and/or the like.

A jobs listing table 3319d may include fields such as, but not limited to: recruiterID, campaignName, jobTitle, skillsRequirements, hiringDate, jobLocation, otherAtttributes and/or the like.

A social network table 3319e may store information relating to employment candidates activities on third-party social media sites and accordingly, may contain fields such as, but not limited to: candidateID, socialHandle, activityDate, activityContent and/or the like.

A campaign table 3319f may store information relating to recruiting campaign implemented on the SRM, and accordingly, may contain fields such as, but not limited to: recruiterID, totalCampaigns, totalMessageSent, totalCampaignViews, totalMessageViews, totalMessageOpens, totalMessageReplies, campaignName and/or the like.

A communications table 3319g may store information on individual messages sent between employment candidates and recruiters within an employment recruiting campaign, and accordingly may contain fields such as, but not limited to: campaignName, recruiterID, candidateID, messageType, messageDate, messageSubject, messageContent and/or the like. A follow-up table 3319h may store message and task follow-up dates established for candidates within an employment recruiting campaign, and accordingly, may contain fields such as, but not limited to: campaignID, taskName, taskDate, taskcompletedFlag, notificationFlag and/or the like.

A student database 3319k may store information on employment candidates who are currently students, which may be maintained by third-parties such as universities, colleges and high schools. Accordingly, the database 3319k may contain fields such as, but not limited to: candidateID, candidateSchool, candidateGraduationDate, candidateGPA, candidateMajor, honorsReceived, graduationDate, degreeType and/or the like.

An alumni database 3319l may store information on employment candidates who are graduates of one or more educational institutions, and accordingly, may contain fields similar to the student database 3319k.

A knowledgebase table 3319m may store predetermined, standardized descriptors of job-related information, such as job titles, job skills, job responsibilities, and the like, along with keyword of such descriptors that might be entered by a candidate. Furthermore, this knowledgebase datastructure may include a prioritized ranking of various standardized job skills that may vary according to job type. Accordingly, the knowledgebase table 3319m may contain fields such as, but not limited to: standardizedJobTitle, keywordJobTitle, standardizedJobSkill, keywordJobSkill skillRank and/or the like.

In one embodiment, the SRM database may interact with other database systems. For example, employing a distributed database system, queries and data access by search SRM component may treat the combination of the SRM database, an integrated data security layer database as a single database entity.

In one embodiment, user programs may contain various user interface primitives, which may serve to update the SRM. Also, various accounts may require custom database tables depending upon the environments and the types of clients the SRM may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 3319a-m. The SRM may be configured to keep track of various settings, inputs, and parameters via database controllers.

The SRM database may communicate to and/or with other components in a component collection, including itself, and/or facilities of the like. Most frequently, the SRM database communicates with the SRM component, other program components, and/or the like. The database may contain, retain, and provide information regarding other nodes and data.

### The SRMs

The SRM component 3335 is a stored program component that is executed by a CPU. In one embodiment, the SRM component incorporates any and/or all combinations of the aspects of the SRM that was discussed in the previous figures. As such, the SRM affects accessing, obtaining and the provision of information, services, transactions, and/or the like across various communications networks. The features and embodiments of the SRM discussed herein increase network efficiency by reducing data transfer requirements the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., will reduce the capacity and structural infrastructure requirements to support the SRM's features and facilities, and in many cases reduce the costs, energy consumption/requirements, and extend the life of SRM's underlying infrastructure; this has the added benefit of making the SRM more reliable. Similarly, many of the features and mechanisms are designed to be easier for users to use and access, thereby broadening the audience that may enjoy/employ and exploit the feature sets of the SRM; such ease of use also helps to increase the reliability of the SRM. In addition, the feature sets include heightened security as noted via the Cryptographic components 3320, 3326, 3328 and throughout, making access to the features and data more reliable and secure.

The SRM transforms automated social information gathering inputs, via SRM components (e.g., information mapping), into activatable social account outputs.

A Candidate component 3340 may coordinate interactions between the employment candidate and the SRM system as described herein.

An Employer component 3341 may coordinate interactions between the recruiters and the SRM system as described herein.

A Monitoring component 3342 may monitor interactions between the employment candidate and the SRM or third-party social media sites to determine when updates are to be made to an employment candidate's profile with new job-related information as described herein.

A Recruiting Campaign component 3343 implements the recruiting campaign functions provided to the recruiters by the SRM system as described herein.

A Campaign Analytics component 3344 performs the campaign monitoring and statistics gathering functions for determining the effectiveness of recruiting campaigns implemented via the SRM as described herein.

A Messaging component 3345 implements the messaging functions between employment candidates and recruiters via recruiting campaigns maintained by the SRM as described herein.

An Employment Listing component 3346 manages the creation and updating of job listings maintained on the SRM system as described herein.

The SRM component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the SRM server employs a cryptographic server to encrypt and decrypt communications. The SRM component may communicate to and/or with other components in a component collection, including itself, and/or facilities of the like. Most frequently, the SRM component communicates with the SRM database, operating systems, other program components, and/or the like. The SRM may contain, communicate, generate, obtain, and/or provide program component, system, user, and/or data communications, requests, and/or responses.

### Distributed SRMs

The structure and/or operation of any of the SRM node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the SRM controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the SRM controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

<?PHP
header(′Content-Type: text/plain′);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of
message
do {

$input = “”;
$input = socket_read($client, 1024);
$data .= $input;

} while($input != “”);
// parse data to extract variables
$obj = json_decode($data, true);
// store input data in a database
mysql_connect(″201.408.185.132″,$DBserver,$password); // access
database server
mysql_select(″CLIENT_DB.SQL″); // select database to append
mysql_query(“INSERT INTO UserTable (transmission)
VALUES ($data)”); // add data to UserTable table in a CLIENT database
mysql_close(″CLIENT_DB.SQL″); // close connection to database
?>

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=/com.ibm
.IBMDI.doc/referenceguide295.htm

and other parser implementations:

http://publib.boulder.ibm.com/infocenter/tivihelp/v2r1/index.jsp?topic=/com.ibm
.IBMDI.doc/referenceguide259.htm

all of which are hereby expressly incorporated by reference.

In order to address various issues and advance the art, the entirety of this application for Social Relation Management Apparatuses, Methods and Systems (including the Cover Page, Title, Headings, Field, Background, Summary, Brief Description of the Drawings, Detailed Description, Claims, Abstract, Figures, Appendices, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components, data flow order, logic flow order, and/or any present feature sets as described in the figures and/or throughout are not limited to a fixed operating order and/or arrangement, but rather, any disclosed order is exemplary and all equivalents, regardless of order, are contemplated by the disclosure. Similarly, descriptions of embodiments disclosed throughout this disclosure, any reference to direction or orientation is merely intended for convenience of description and is not intended in any way to limit the scope of described embodiments. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should not be construed to limit embodiments, and instead, again, are offered for convenience of description of orientation. These relative descriptors are for convenience of description only and do not require that any embodiments be constructed or operated in a particular orientation unless explicitly indicated as such. Terms such as “attached,” “affixed,” “connected,” “coupled,” “interconnected,” and similar may refer to a relationship wherein structures are secured or attached to one another either directly or indirectly through intervening structures, as well as both movable or rigid attachments or relationships, unless expressly described otherwise. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a SRM individual and/or enterprise user, database configuration and/or relational model, data type, data transmission and/or network framework, syntax structure, and/or the like, various embodiments of the SRM, may be implemented that enable a great deal of flexibility and customization. For example, aspects of the SRM may be adapted for client relations management in a social network. While various embodiments and discussions of the SRM have included automated client and social outreach, however, it is to be understood that the embodiments described herein may be readily configured and/or customized for a wide variety of other applications and/or implementations.

1. An employment facilitation apparatus, comprising:
a memory;
a component collection in the memory, including:
an Employment Candidate Profile component, and
a Candidate Monitoring component;
a processor disposed in communication with said memory, and configured to issue a plurality of processing instructions from the stored in the memory, wherein the processor issues instructions from the Employment Candidate Profile component, stored in the memory, to:
receive at least one e-mail address of an employment candidate;
obtain employment-related information from a plurality of disparate social media sites based on the at least one e-mail address of the employment candidate;
populate fields of a candidate profile of the employment candidate with the employment-related information obtained from the social media sites; and
generate a pre-formatted résumé for the employment candidate from the fields of the candidate profile;
wherein the processor issues instructions from the Candidate Monitoring component, stored in the memory, to:
obtain an update to a social media profile from a social media site, without action from the employment candidate,
determine whether the update comprises additional employment-related information;
when the update comprises additional employment-related information, including the additional employment-related information in the pre-formatted résumé; and
display the pre-formatted résumé with the additional employment-related information to at least one of the employment candidate and an employment recruiter.

2. The apparatus of claim 1, wherein the employment candidate profile corresponds to an inactive employment candidate account.

3. The apparatus of claim 1, wherein the employment candidate profile corresponds to an active employment candidate account.

4. The apparatus of claim 1, wherein the employment related information and the additional employment-related information are determined based on comparisons of words therein to a knowledgebase data structure comprising standard employment-related terms.

5. The apparatus of claim 4, wherein the established employment-related terms are used to update the pre-formatted résumé of the employment candidate.

6. The apparatus of claim 1, wherein the update to the social media profile comprises an update to a social media profile established by the employment candidate.

7. The apparatus of claim 1, wherein the update to the social media profile comprises an update to a social media profile established by a party other than the employment candidate, and which includes a post that references the employment candidate.

8. The apparatus of claim 1, further comprising:
an Employment Listing Component, and
wherein the processor issues instructions from the Employment Listing Component, stored in the memory, to:
obtain employment listings from a plurality of employment recruiters;
receive a search request from the employment candidate, the search request corresponding to a type of employment and a location of employment for retrieval from the employment listings;
determine an employment listing from a recruiter that matches the search request; and
display the employment listing to the employment candidate.

9. The apparatus of claim 8, further comprising:
a Recruiting Campaign Component, and
wherein the processor issues instructions from the Recruiting Campaign Component, stored in the memory, to:
obtain a plurality of employment requirements for an employment position available from an employment recruiter;
determine the employment listing from the plurality of employment requirements; and
provide the employment listing to the Employment Listing Component.

10. The apparatus of claim 8, wherein when the employment candidate submits the pre-formatted résumé in response to the employment listing, the processor issues instructions from the Candidate Monitoring Component, stored in the memory, to:
update the candidate profile of the employment candidate based on interest of the employment candidate in the employment listing.

11. The apparatus of claim 10, further comprising:
a Messaging Component, and
wherein the processor issues instructions from the Messaging Component, stored in the memory, to:
obtain an acknowledgement that the employment candidate submitted the pre-formatted résumé in response to the employment listing;
determine a response time to generate a reply message to the employment candidate; and
provide a reminder to a recruiter corresponding to the employment listing to generate the reply message upon an expiration of the response time.

12. The apparatus of claim 1, wherein the processor issues instructions from the Employment Candidate Profile component, stored in the memory, to:
transmit questions to the employment candidate regarding employment qualifications;
obtain a plurality of responses to the questions from the employment candidate;
determine an additional update to the pre-formatted résumé based on the plurality of responses; and
display the pre-formatted résumé with the additional update to at least one of the employment candidate and an employment recruiter.

13. A processor-readable employment facilitation medium storing processor-executable components, the components, comprising:
a component collection stored in the medium, including:
an Employment Candidate Profile component, and
a Candidate Monitoring component;
wherein the Employment Candidate Profile component, stored in the medium, includes processor-issuable instructions to:
receive at least one e-mail address of an employment candidate;
obtain employment-related information from a plurality of disparate social media sites based on the at least one e-mail address of the employment candidate;
populate fields of a candidate profile of the employment candidate with the employment-related information obtained from the social media sites; and
generate a pre-formatted résumé for the employment candidate from the fields of the candidate profile; and
wherein the Candidate Monitoring component, stored in the medium, includes processor-issuable instructions to:
obtain an update to a social media profile of the employment candidate from a social media site, without action from the employment candidate,
determine whether the update comprises additional employment-related information;
when the update comprises additional employment-related information, including the additional employment-related information in the pre-formatted résumé; and
display the pre-formatted résumé with the additional employment-related information to at least one of the employment candidate and an employment recruiter.

14. A processor-implemented employment facilitation system, comprising:
an Employment Candidate Profile component means, to:
receive at least one e-mail address of an employment candidate;
obtain employment-related information from a plurality of disparate social media sites based on the at least one e-mail address of the employment candidate;
populate fields of a candidate profile of the employment candidate with the employment-related information obtained from the social media sites; and
generate a pre-formatted résumé for the employment candidate from the fields of the candidate profile; and
a Candidate Monitoring component means, to:
obtain an update to a social media profile of the employment candidate from a social media site, without action from the employment candidate,
determine whether the update comprises additional employment-related information;
when the update comprises additional employment-related information, including the additional employment-related information in the pre-formatted résumé; and
display the pre-formatted résumé with the additional employment-related information to at least one of the employment candidate and an employment recruiter.

15. (canceled)

16. An employment facilitating method, comprising:
receiving at least one e-mail address of an employment candidate;
obtaining employment-related information from a plurality of disparate social media sites based on the at least one e-mail address of the employment candidate;
populating fields of a candidate profile of the employment candidate with the employment-related information obtained from the social media sites; and
generating a pre-formatted résumé for the employment candidate from the fields of the candidate profile;
obtaining an update to a social media profile of the employment candidate from a social media site, without action from the employment candidate,
determining whether the update comprises additional employment-related information;
including the additional employment-related information in the pre-formatted résumé when the update comprises additional employment-related information; and
displaying the pre-formatted résumé with the additional employment-related information to at least one of the employment candidate and an employment recruiter.

17. The medium of claim 13, wherein the employment candidate profile corresponds to an inactive employment candidate account.

18. The medium of claim 13, wherein the employment candidate profile corresponds to an active employment candidate account.

19. The medium of claim 13, wherein the employment related information and the additional employment-related information are determined based on comparisons of words therein to a knowledgebase data structure comprising standard employment-related terms.

20. The medium of claim 19, wherein the established employment-related terms are used to update the pre-formatted résumé of the employment candidate.

21. The medium of claim 13, wherein the update to the social media profile comprises an update to a social media profile established by the employment candidate.

22. The medium of claim 13, wherein the update to the social media profile comprises an update to a social media profile established by a party other than the employment candidate, and which includes a post that references the employment candidate.

23. The medium of claim 13, further comprising:
an Employment Listing Component, and
wherein the processor issues instructions from the Employment Listing Component, stored in the memory, to:
obtain employment listings from a plurality of employment recruiters;
receive a search request from the employment candidate, the search request corresponding to a type of employment and a location of employment for retrieval from the employment listings;
determine an employment listing from a recruiter that matches the search request; and
display the employment listing to the employment candidate.

24. The medium of claim 23, further comprising:
a Recruiting Campaign Component, and
wherein the processor issues instructions from the Recruiting Campaign Component, stored in the memory, to:
obtain a plurality of employment requirements for an employment position available from an employment recruiter;
determine the employment listing from the plurality of employment requirements; and
provide the employment listing to the Employment Listing Component.

25. The medium of claim 23, wherein when the employment candidate submits the pre-formatted résumé in response to the employment listing, the processor issues instructions from the Candidate Monitoring Component, stored in the memory, to:
update the candidate profile of the employment candidate based on interest of the employment candidate in the employment listing.

26. The medium of claim 25, further comprising:
a Messaging Component, and
wherein the processor issues instructions from the Messaging Component, stored in the memory, to:
obtain an acknowledgement that the employment candidate submitted the pre-formatted résumé in response to the employment listing;
determine a response time to generate a reply message to the employment candidate; and
provide a reminder to a recruiter corresponding to the employment listing to generate the reply message upon an expiration of the response time.

27. The medium of claim 13, wherein the processor issues instructions from the Employment Candidate Profile component, stored in the memory, to:
transmit questions to the employment candidate regarding employment qualifications;
obtain a plurality of responses to the questions from the employment candidate;
determine an additional update to the pre-formatted résumé based on the plurality of responses; and
display the pre-formatted résumé with the additional update to at least one of the employment candidate and an employment recruiter.

28. The system of claim 14, wherein the employment candidate profile corresponds to an inactive employment candidate account.

29. The system of claim 14, wherein the employment candidate profile corresponds to an active employment candidate account.

30. The system of claim 14, wherein the employment related information and the additional employment-related information are determined based on comparisons of words therein to a knowledgebase data structure comprising standard employment-related terms.

31. The system of claim 30, wherein the established employment-related terms are used to update the pre-formatted résumé of the employment candidate.

32. The system of claim 14, wherein the update to the social media profile comprises an update to a social media profile established by the employment candidate.

33. The system of claim 14, wherein the update to the social media profile comprises an update to a social media profile established by a party other than the employment candidate, and which includes a post that references the employment candidate.

34. The system of claim 14, further comprising:
an Employment Listing Component, and
wherein the processor issues instructions from the Employment Listing Component, stored in the memory, to:
obtain employment listings from a plurality of employment recruiters;
receive a search request from the employment candidate, the search request corresponding to a type of employment and a location of employment for retrieval from the employment listings;
determine an employment listing from a recruiter that matches the search request; and
display the employment listing to the employment candidate.

35. The system of claim 34, further comprising:
a Recruiting Campaign Component, and
wherein the processor issues instructions from the Recruiting Campaign Component, stored in the memory, to:
obtain a plurality of employment requirements for an employment position available from an employment recruiter;
determine the employment listing from the plurality of employment requirements; and
provide the employment listing to the Employment Listing Component.

36. The system of claim 34, wherein when the employment candidate submits the pre-formatted résumé in response to the employment listing, the processor issues instructions from the Candidate Monitoring Component, stored in the memory, to:
update the candidate profile of the employment candidate based on interest of the employment candidate in the employment listing.

37. The system of claim 36, further comprising:
a Messaging Component, and
wherein the processor issues instructions from the Messaging Component, stored in the memory, to:
obtain an acknowledgement that the employment candidate submitted the pre-formatted résumé in response to the employment listing;
determine a response time to generate a reply message to the employment candidate; and
provide a reminder to a recruiter corresponding to the employment listing to generate the reply message upon an expiration of the response time.

38. The system of claim 14, wherein the processor issues instructions from the Employment Candidate Profile component, stored in the memory, to:
transmit questions to the employment candidate regarding employment qualifications;
obtain a plurality of responses to the questions from the employment candidate;
determine an additional update to the pre-formatted résumé based on the plurality of responses; and
display the pre-formatted résumé with the additional update to at least one of the employment candidate and an employment recruiter.

39. The method of claim 16, wherein the employment candidate profile corresponds to an inactive employment candidate account.

40. The method of claim 16, wherein the employment candidate profile corresponds to an active employment candidate account.

41. The method of claim 16, wherein the employment related information and the additional employment-related information are determined based on comparisons of words therein to a knowledgebase data structure comprising standard employment-related terms.

42. The method of claim 41, wherein the established employment-related terms are used to update the pre-formatted résumé of the employment candidate.

43. The method of claim 16, wherein the update to the social media profile comprises an update to a social media profile established by the employment candidate.

44. The method of claim 16, wherein the update to the social media profile comprises an update to a social media profile established by a party other than the employment candidate, and which includes a post that references the employment candidate.

45. The method of claim 16, further comprising:
an Employment Listing Component, and
wherein the processor issues instructions from the Employment Listing Component, stored in the memory, to:
obtain employment listings from a plurality of employment recruiters;
receive a search request from the employment candidate, the search request corresponding to a type of employment and a location of employment for retrieval from the employment listings;
determine an employment listing from a recruiter that matches the search request; and
display the employment listing to the employment candidate.

46. The method of claim 45, further comprising:
a Recruiting Campaign Component, and
wherein the processor issues instructions from the Recruiting Campaign Component, stored in the memory, to:
obtain a plurality of employment requirements for an employment position available from an employment recruiter;
determine the employment listing from the plurality of employment requirements; and
provide the employment listing to the Employment Listing Component.

47. The method of claim 45, wherein when the employment candidate submits the pre-formatted résumé in response to the employment listing, the processor issues instructions from the Candidate Monitoring Component, stored in the memory, to:
update the candidate profile of the employment candidate based on interest of the employment candidate in the employment listing.

48. The method of claim 47, further comprising:
a Messaging Component, and
wherein the processor issues instructions from the Messaging Component, stored in the memory, to:
obtain an acknowledgement that the employment candidate submitted the pre-formatted résumé in response to the employment listing;
determine a response time to generate a reply message to the employment candidate; and
provide a reminder to a recruiter corresponding to the employment listing to generate the reply message upon an expiration of the response time.

49. The method of claim 16, wherein the processor issues instructions from the Employment Candidate Profile component, stored in the memory, to:
transmit questions to the employment candidate regarding employment qualifications;
obtain a plurality of responses to the questions from the employment candidate;
determine an additional update to the pre-formatted résumé based on the plurality of responses; and
display the pre-formatted résumé with the additional update to at least one of the employment candidate and an employment recruiter.
